(19) United States
(12) Patent Application Publication
(10) Pub. No.: US 2014/0235315 A1
(43) Pub. Date: Aug. 21, 2014

(54) Rolling Raffle Game, Prize Method, and Distribution Method

(71) Applicant: Michael Hughes, Thousand Oaks, CA (US)

(72) Inventor: Michael Hughes, Thousand Oaks, CA (US)

(21) Appl. No.: 14/140,466

(22) Filed: Dec. 24, 2013

Related U.S. Application Data
(63) Continuation of application No. 13/475,943, filed on May 19, 2012.
Application No. 13/475,943 is a continuation of application No. 12/671,513, filed on Jan. 31, 2010, now abandoned.
Application No. 12/671,513 is a continuation of application No. 13/372,623, filed on Feb. 14, 2012, now Pat. No. 8,613,653.
Application No. 13/372,623 is a continuation of application No. 11/906,597, filed on Oct. 3, 2007, now Pat. No. 8,118,658.
Application No. 11/906,597 is a continuation of application No. 11/882,147, filed on Jul. 31, 2007, now abandoned.

(51) Int. Cl. G07F 17/32

(52) U.S. Cl. CPC G07F 17/329
USPC 463/17

(57) ABSTRACT

For a premium wager, a raffle game is added to a lottery game play. All players of the base game (who purchased the add-on game or not) who achieve a pre-determined outcome receive a raffle game play which is entered into a raffle drawing at no additional cost. The raffle drawing is held, and the winning raffle outcome is identified. Winning raffle ticket recipients submit their tickets to the lottery authority for their prize. A determination is made if the add-on game was purchased with the base game play associated to the winning raffle ticket. If the add-on game was purchased with the base game play, the player receives the raffle prize.

### TECHNICAL FIELD

The present invention relates generally to games of chance, such as state or nationally sponsored lotto/lottery games, but can be applied to other games of chance as well, such as bingo games, casino games, or any other type of venue which contains an unpredictable outcome that a player participates in. More specifically, the invention is a progressive raffle add-on game that is added to a base game of chance where the prize for a winning outcome is influenced by the wager a player placed upon playing the base game play. Also, an improved method of allocating game prize pools to prize payouts is presented which will enhance player momentum while limiting the risk assumed by gaming hosts. For conceptual purposes, the present invention will be described as applied to state lottery games hereunder, but shall not be viewed as fixed or limited to such application.

### BACKGROUND ART

While each national/state lottery has its own rules which vary slightly and are usually published on their websites, and while some states/nations now permit the purchase of lottery tickets through the internet, the following is just one example of basic lotto rules or regulations, how to play the game, and game summary which are presented for foundational purposes and should additionally not be viewed as fixed or limiting.

Lotto Game Summary:

A player chooses six numbers from 1 to 49. Six numbers are drawn plus a bonus number, out of 49 numbered balls. If a player matches all 6 numbers, they win the jackpot. If they match 5 numbers and the bonus number, they win the second highest prize. If they match five, four or three numbers, they can win smaller prizes.

How to Play Lotto:

First, mark six numbers on any individual lottery board or lottery play slip. On some lottery play slips a player can play with more than one set of numbers. A player can also buy tickets without completing a play slip. The player allows the computer terminal choose six-number combinations at random.

Some play slips allow a player to play the same numbers for more than one week (for several draws). The player needs to mark the appropriate section accordingly. The player will only receive one ticket, but their numbers will be entered for the draw-days and number of weeks selected.

A player takes the completed lottery play slip to a retailer or lottery terminal. They will enter the player's selections into the terminal and give the player a Lotto/Lottery game ticket. The player is responsible for checking that the information it contains is correct—the numbers, the days they wish to play, the number of weeks and the draw date(s).

Where applicable, they must also check that the bar-coded serial number on the ticket is clearly readable and that the “Void” box has not been marked. The player is encouraged to keep their ticket safe as they'll need it to claim their prize, as it is the only proof that they are a winner. It is recommended that they put their name and address on the reverse of the ticket for security purposes.

If any of the six-number Lottery/Lotto game selections on their ticket matches the main six numbers drawn in the relevant Lottery/Lotto game draw—in any order—they are a jackpot winner. In some cases, they may have to share the jackpot with other winners. They can also win smaller amounts by matching five, four or even three main numbers out of six. In some states/nations, if they have matched five numbers already, matching the bonus number will win them the second highest prize.

Basic Lotto/Lottery Game Rules and Regulations for Popular Lotteries:
A player must be 16/18/21 years of age or older to buy Lotto/Lottery tickets and claim prizes.
Players are responsible for checking their tickets before leaving the retailer location.
A ticket is void if stolen, unissued, mutilated, illegible, tampered with or altered in any way, defective or incomplete.
The Lottery is not responsible for lost or stolen tickets.
A Lotto/Lottery ticket may be cancelled only if presented before the drawing to the Retailer where it was originally purchased.
A player must fill in their name, address and phone number on the back of their winning ticket before they file a prize claim.
All winning tickets are subject to validation by the Lottery.
All winning tickets are bearer instruments.
All prizes must be claimed within 6 months/one year from date of drawing.

Lottery games have always been popular, and have provided consistently growing revenues for education in many states/nations.

Industry research shows lottery games with higher overall payouts and payout chances create more “winning experiences” for players, and sell better. Almost 10 years ago, many states began to introduce premium variations of traditional scratch-off, instant win lottery tickets. For a higher price such as $2.00-$10.00 instead of the traditional $1.00, players could experience multiple winning opportunities or better odds with higher payouts, which enhanced their overall chances and playing experience. As a result, scratch-off, instant win lottery ticket revenues have surpassed traditional lotto revenues in many states, and continue to thrive while traditional lotto revenues remain stagnant, and in some states are consistently declining.

Of particular interest is the observation of Lotto/Lottery game analysts that consumers are most receptive to purchasing a new game in the first 4 weeks it is offered for sale. This puts the burden on game designers to constantly create new, innovative gaming ideas or a means for consistently repackaging existing games to appear fresh.

Efforts to raise traditional lotto sales, such as increasing drawings from 1× week to 2× a week, have been implemented, but due to the already high payout expectation in the minds of consumers, lottery authorities have been challenged to provide a fresh lotto innovation that would demand a ticket price higher than the traditional $1.00 per ticket.

In recent years, several state lotteries have incorporated a raffle on an annual or semi-annual basis as seen in FIG. 2. One of the most popular state raffles is named the Millionaire Raffle and offers players the best odds to win $1 million dollars, where sponsoring states offer a limited number of raffle tickets at an average price of $20 per ticket. Each ticket contains one unique number which is included in a raffle drawing. The total amount of the prizes offered is typically close to 50% of the total revenues generated by the particular raffle drawing, and are typically divided amongst several fixed $1 million, $100000, $10,000 and $500 prizes. The amount of fixed prizes and prize amounts are predetermined by each state lottery before tickets are sold.

Raffle games such as the Millionaire Raffle have been widely and enthusiastically accepted by players across all states, with many raffle tickets selling out only days or weeks after tickets are offered for sale, and only a handful of smaller state lotteries have completed their sales period with unsold tickets remaining.

As successful as state raffle drawings have been however, the very nature & structure of a raffle drawing offers several limitations to the sponsoring state's efforts in increasing revenues. The most apparent limitations are as follows: (1) An average ticket price between $10-$20 is much higher than the cost of a traditional lottery ticket, and may be more than the typical lottery player is willing to pay on an on-going basis. (2) The number of fixed prizes offered is typically based on the assumption that all tickets will be sold; offering a number of fixed prizes which are not determined on a pari-mutuel basis transfers the risk to the sponsoring lottery if all the tickets are not sold. (3) A raffle drawing can be a cannibal game, absorbing funds that would otherwise be spent on other state lottery games. (4) Promoting the typical raffle game is time consuming, often requiring a 6-8 week sales period for a single raffle drawing, and (5) the very nature of a raffle dictates that all prizes are paid out in a single drawing which prevents the typical raffle game from utilizing the most influential factor in increasing game sales known to date; the rolling jackpot. As seen In FIG. 3, a case study of the 2006 ticket sales of the Florida Lotto™ game shows that the average number of ticket sales increase by over 500 percent (500%) when a larger jackpot is available.

Of background interest is application WO 2007/092530 by SCIENTIFIC GAMES ROYALTY CORP ET AL titled LOTTERY GAME HAVING AN INDEPENDENT RAFFLE PRIZE. SCIENTIFIC teaches of a lottery game with a capped jackpot prize and increasing raffle prize where if there is no jackpot winner for the lottery game drawing, the jackpot is increased until the jackpot is at least equal to a predefined value. If there is no jackpot winner for the lottery game drawing and the jackpot prize is at least equal to a predefined value, a raffle prize is established. If there is no jackpot winner for the lottery game drawing and a raffle prize is established, the raffle prize is incremented.

While a novel means of incorporating a raffle to an on-line lottery game, there are disadvantages which may limit the commercialization of such a game. (1) While the game is in the spirit of a raffle, it offers a limited number of prizes, as each prize is Si million dollars (2) Capping the jackpot prize of the base game may cause players to lose interest rather than promote interest (3) the drawings depict a $2.00 price per play indicating a premium cost over the traditional $1.00 to play such a game. A concern is until the jackpot exceeds the minimum threshold to trigger the raffle game, if players would be willing to pay the additional cost vs. 2 plays of a traditional on-line lottery game. (4) The game can be a cannibal game, absorbing funds that would otherwise be spent on other state lottery games. (5) The aspect of the raffle prizes is not being distributed to the raffle winners until a jackpot winner is determined might be a turn-off for faithful players who have paid the premium wager, received their raffle numbers, realized they were in possession of a winning $1 million raffle ticket, then not receiving the jackpot through no fault of their own. Therefore, an improved raffle game which addresses the aforementioned shortcomings of the prior art is still needed.

### DISCLOSURE OF INVENTION

Turning now descriptively to the drawings, the attached figures illustrate various embodiments of a game of chance add-on raffle game, an independent raffle game, and a pari-mutuel system for funding the raffle game prize payout. In one embodiment, the present invention is an add-on raffle game to be added to a casino game of chance, a bingo game, sporting venue, or any venue with an unpredictable outcome that a player can participate in.

In this respect, before explaining at least one embodiment of the invention in detail, it is to be understood that the invention is not limited in its application to the details of the arrangements of the components set forth in the following description, steps or illustrations. Additionally, it is to be understood that the phraseology and terminology employed herein, including game instructions, game cost, amount of numbers selected to play, amount of matching indicia required for a winning or qualifying outcome are for the purpose of the description and should not be regarded as limiting. The add-on game as depicted in one embodiment of the present invention is referred to herein as Lightning Strikes Twice™ (“LST”); a name trademarked for use with the present embodiment. A single add-on game play, base game play, jackpot game play, raffle game play and on-line game play are referred to herein as add-on game, base game, jackpot game, raffle game and on-line game.

FIG. 1. depicts the premise of the add-on raffle game, according to one embodiment of the present invention. An on-line lottery game play is offered by the lottery authority to the public for a wager. For a premium wager, i.e. $1.00 extra, an add-on raffle game play is offered to be added to the on-line lottery game play at the time of the initial base game play purchase 100. In one embodiment, the add-on game play is played in a single state, jurisdiction or country, or simultaneously in a plurality of states, jurisdictions or countries and is added to either jackpot games only, instant games (scratch-off tickets) or all on-line games. If played simultaneously in a plurality of states, jurisdictions or countries, a percentage of revenues received from ticket sales would be allocated to the states the ticket sales originated in, and a percentage of revenues received from ticket sales would be allocated to at least one prize pool across all participating states, jurisdictions, or countries.

The lottery authority receives player indicia and a wager from a player 102. In one embodiment, the lottery authority receives a request for a quick pick game play in lieu of presenting player indicia. The lottery authority generates a game play ticket with the set of player indicia 104. In one embodiment, an indication whether or not the raffle add-on game was purchased along with the base game is printed on the game ticket. The lottery authority holds a lottery drawing and identifies the winning lottery indicia 106. Players submit their game play ticket to the lottery authority 108, which makes a determination on their game play outcome 110; all players of the base game (who purchased the add-on game or not) who achieve a pre-determined outcome, i.e. matching at least 3 winning numbers in a base game drawing qualify to participate in a subsequent raffle drawing, and will, upon their ticket redemption, receive a raffle game play ticket containing unique raffle indicia that will automatically be entered into a raffle drawing at no additional cost 112. If the game play outcome does not achieve the pre-determined outcome, the game is over for the player. In one embodiment, the raffle ticket contains an indication of whether or not the add-on raffle game was purchased with the associated base game play. In one embodiment, the qualifying outcome to receive a raffle ticket is determined by the lottery authority, i.e. the qualifying outcome that normally results in awarding a free QP lottery ticket could be the qualifying event to award the raffle ticket instead. In one embodiment, the unique raffle indicia is issued at the time of the initial base game purchase and is printed on all base game tickets.

The add-on game raffle drawing is held periodically, i.e. weekly, and is where winning raffle numbers are identified. In one embodiment, each raffle drawing offers a number of fixed cash prizes and a pari-mutuel grand prize. In one embodiment, fifty percent of the prize pool is allocated to a number of fixed prizes, the other fifty percent of the prize pool is allocated to a grand prize. In one embodiment, the complete prize pool is allocated to either a number of fixed prizes or a pan-mutual grand prize.

The raffle drawing is held, and the official winning raffle indicia are identified 114. Players submit their raffle ticket to the lottery authority 116, which makes a determination on their raffle play outcome 118. If their raffle indicia do not match the indicia selected as the official winning raffle indicia for the drawing, the game is over for the player. If their raffle indicia do match any of the indicia selected as the official winning raffle indicia for the drawing, a determination is made whether the add-on raffle game was purchased along with the base game play associated to the winning raffle ticket 120. If the add-on raffle game was purchased with base game play associated to the winning raffle ticket, the player receives the associated raffle prize 122. If the add-on raffle game was not purchased with base game play associated to the winning raffle ticket, the player receives a free QP lottery game play in lieu of receiving the raffle prize 124. In one embodiment, the player receives no prize, a game play for a subsequent drawing or an amount lesser than if they had purchased the add-on raffle game while purchasing the base game.

The unpaid raffle prize or a percentage of the unpaid raffle prize will rollover to a subsequent raffle drawing 126. In one embodiment, a rolldown prize structure is offered where in the event that a raffle prize is riot awarded, a percentage of the prize money is allocated to smaller prizes in the same drawing rather than being carried forward to enhance prizes of a subsequent drawing. In one embodiment, there are “non-winning” raffle numbers or “non-winning units” entered into a raffle drawing for the purpose of offering unpredictability in a raffle prize payout. If a non-winning raffle number or non-winning unit is drawn, the prize associated to that particular draw is not awarded. In one embodiment, the unpaid prize rolls over to a subsequent drawing. In one embodiment, the number of “non-winning” raffle numbers or “non-winning units” entered into a drawing is associated to an unpredictable event, i.e., the number of winners who successfully achieve a pre-determined outcome, i.e. match 3 numbers, or the total number of plays in a base game.

In one embodiment of the present invention, a unique raffle number is randomly issued on only some of the base game tickets, and prints along with the initial base game play or is printed on the base game tickets. All raffle numbers are entered into a subsequent drawing, and all prizes are awarded to all recipients of winning raffle numbers.

FIG. 2 is a table depicting the data of raffles currently offered by state lotteries throughout the United States. Non-existent only years earlier, state raffle games are currently offered in 20 different states 200, proving to be one of the fastest growing games in present times.

FIG. 3 is a table depicting the relationship between the average jackpot size and the corresponding amount of ticket sales based on 2006 data published by the Florida Lotto game. As depicted, an incrementing jackpot breeds excitement and player interest, with play activity up over 500% 300 when larger jackpots are offered.

FIG. 4 depicts a plan front view of a lotto ticket 400 and raffle ticket 402 of the add-on game of the present invention. The lotto ticket 400 depicts a premium price per play of $2.00 404 and a Lightning Strikes Twice (“LST”) checkbox 406, indicating whether or not the player purchased the add-on raffle game of the present invention while purchasing the base game. The raffle ticket 402 depicts a unique raffle indicia 408 that will automatically be entered into the following Lightning Strikes Twice™ raffle drawing. The raffle ticket 402 does not have a depicted price, as it is obtained at no additional cost by all base game players who successfully match at least 3 official winning numbers in a base game, as defined in one embodiment of the present invention, or another qualifying outcome as determined by the lottery. The raffle ticket 402 does depict a Lightning Strikes Twice (“LST”) checkbox 406, indicating whether or not the player purchased the add-on game of the present invention while purchasing the base game. In one embodiment, a player is required to purchase the raffle ticket.

FIG. 6 is a chart depicting the allocation of the prize pool of the add-on game of the present invention. In one embodiment, the prize pool 600 is a pan-mutual prize pool and consists of 50 percent (50%) of the monies from the sale of the add-on game of the present invention over a drawing period. In one embodiment, the prize pool also contains prize monies carried forward from previous drawings. In one embodiment, a percentage of the gross revenue from the sale of the add-on game of the present invention over a drawing period is allocated to at least one prize reserve account before being allocated to the prize pool 600. The prize pool shall be allocated as the winning pool for the payment of prizes as provided below.

In one embodiment, the grand prize pool 602 shall consist of 50 percent (50%) of the prize pool 600 over a drawing period plus any unpaid grand prize money carried forward from previous drawings. In one embodiment, if the grand prize winner in a drawing did not purchase the add-on game of the present invention at the time the base game play was purchased, the winner will receive a free QP lottery ticket in lieu of the associated grand prize, which is funded by a reserve pool. The grand prize amount allocated to that winning raffle ticket will not be awarded and shall be carried over and added to the grand prize pool 602 of a subsequent drawing. In one embodiment, money in the grand prize pool 602 is multiplied by an annuity factor or similar multiple to determine a published grand prize amount, whereby the grand prize amount is paid out to a winner, through an annuity or similar financial instrument, in a series of payments over a multiple of years. In one embodiment, grand prizes awarded are paid as single, lump sum prizes. In one embodiment, the grand prize pool 602 is known as the jackpot pool and the grand prize is known as the jackpot.

The fixed prize pool 604 shall consist of 50 percent (50%) of the prize pool 600 over a drawing period plus any unpaid fixed prize money carried forward from previous draws. In one embodiment, the fixed prize pool 604 is allocated to a number of fixed $1 million, $100,000, $10,000, arid $500 prize units, defined by the following formula:
(a) Seventy-five percent (75%) of the fixed prize pool, rounded down to the nearest million dollar denomination, shall be allocated to the maximum number of million dollar prize units 606;
(b) Seventy-five percent (75%) of the remaining fixed prize pool, rounded down to the nearest hundred thousand dollar denomination, shall be allocated to the maximum number of hundred thousand dollar prize units 608;
(c) Seventy-five percent (75%) of the remaining fixed prize pool, rounded down to the nearest ten thousand dollar denomination, shall be allocated to the maximum number of ten thousand dollar prize units 610;
(d) One hundred percent (100%) of the remaining fixed prize pool, rounded down to the nearest five hundred dollar denomination, shall be allocated to the maximum number of five hundred dollar prize units 612;
(e) One hundred percent (100%) of the remaining fixed prize pool shall be placed in trust in one or more prize reserve accounts for QP lottery ticket prizes 614. In one embodiment, once the prize reserve accounts exceed a pre-designated amount, the excess shall become part of the following fixed prize pool 604.

In one embodiment, the allocation of the fixed prize pool 604 may be modified to positively impact sales as determined by the sponsoring state lottery. The modification of the fixed prize pool allocation may include different allocation percentages and a number of different fixed prize amounts, including but not limited to Ten Million Dollar prize units ($10,000,000), Five Million Dollar prize units ($5,000,000), Two Million Dollar prize units ($2,000,000), One Million Dollar prize units ($1,000,000), Five Hundred Thousand Dollar prize units ($500,000), Two Hundred Fifty Thousand Dollar prize units ($250,000), One Hundred Thousand Dollar prize units ($100,000), Fifty Thousand Dollar prize units ($50,000), Twenty Five Thousand Dollar prize units ($25,000), Ten Thousand Dollar prize units ($10,000), Five Thousand Dollar prize units ($5,000), One Thousand Dollar prize units ($1,000), Five Hundred Dollar prize units ($500), Two Hundred Fifty Dollar prize units ($250), One Hundred Dollar prize units ($100), and QP lottery ticket prize units.

In one embodiment, if a fixed prize winner in a drawing did not purchase the add-on game of the present invention at the time the base game play was purchased, the winner will receive a free QP lottery ticket in lieu of the associated fixed prize, which is funded by a reserve pool. The fixed prize amount allocated to that winning raffle ticket will not he awarded and shall be carried over and added to the fixed prize pool 604 of a subsequent drawing. In one embodiment, fixed prizes awarded are paid as single, lump sum prizes or annuitized prizes. In one embodiment, the prize pool 600 is allocated to only the grand prize pool 602 or the fixed prize pool 604.

FIG. 7. is a model developed using the premise of the add-on game of the present invention as applied to a plurality of existing state lottery jackpot games. The model depicts a hypothetical weekly add-on raffle game drawing using actual ticket sales data and the number of winners matching at least 3 numbers in the Florida lottery jackpot games (base games) Lotto™, Mega Money®, and Fantasy 5™, between the dates Jan. 1-Jul. 1, 2006, as published by the Florida lottery. The model comprises a multiple of sections; ticket sales 700, fixed (set) prizes 710, grand prize 720, and odds, 730, further described as follows.

The Ticket Sales section 700 depicts total base game ticket sales 702 over each weekly draw period 701, a hypothetical sell through percentage 704 of the add-on game of the present invention, and the resulting amount of ticket sales 706 and weekly prize pool 708 for the add-on game of the present invention for each weekly draw period 701.

The Fixed (Set) Prizes section 710 depicts the amount of money in the fixed prize pool 712, which is comprised of 50% of the prize pool 708 over each weekly sales period plus any unpaid fixed prize amounts carried forward from previous draws, as previously described. Using the formula previously described, the fixed prize pool 712 is allocated to a number of $1 million prize units 714, $100,000 prize units 715, $10,000 prize units 716, $500 prize units 717, with the remaining balance allocated towards the QP ticket reserve 718. This section also depicts the percentage of prizes hypothetically paid out 719 over each weekly draw period, which correlates to the hypothetical sell through percentage 704 of the add-on game of the present invention. If only 10% of all base game players purchased the add-on game of the present invention, then statistically, no more than 10% of the recipients of winning raffle tickets purchased the add-on game of the present invention, and will receive a prize payout. In this example, 10% of the fixed prize amounts 714-717 are paid out, and the remaining 90% of fixed prize amounts 714-717 rollover to the subsequent drawing.

The Grand Prize section 720 depicts the amount of money in the grand prize pool 722, which is comprised of 50% of the prize pool 708 over each weekly sales period plus any unpaid fixed prize amounts carried forward from previous draws, as previously described. The grand prize pool 722 is multiplied by an annuity factor, as previously described, to determine the published annuitized grand prize 724. This section also contains a hypothetical column of grand prize winners 726, which depicts the hypothetical payout of the grand prize 724, and a column depicting the probability of a grand prize payout 728. Since the grand prize 724 is a single prize, each drawing will result in a complete payout or no payout at all. If only 10% of all base game players purchased the add-on game of the present invention, then statistically, there would be no more than a 10% probability that the recipient of the winning grand prize raffle ticket purchased the add-on game of the present invention, and will receive the grand prize payout. In the drawings in which the hypothetical grand prize is not paid out, the grand prize amount rolls over to the subsequent drawing. As the amount of fixed prizes 710 and grand prize amount 720 increases, a higher sell through percentage 704 is projected. As a higher percentage of players purchase the add-on game of the present invention, there is a higher likelihood that the fixed prizes 710 and grand prize 720 will be paid out in a particular draw.

The Odds section 730 reflects the amount of base game qualifiers 732, or “winners” in each draw period who have successfully matched at least 3 numbers in the Florida lottery jackpot games (base games) Lotto™, Mega Money®, and Fantasy 5™, between the dates Jan. 1-Jul. 1, 2006, as published by the Florida lottery, as well as the number of raffle prizes offered 734 in each weekly draw period, and the odds of winning a raffle prize 736 in each raffle draw period. The actual odds of winning a raffle prize for a raffle ticket recipient is determined by both the amount of winning base game tickets that are redeemed during the draw period, and the number of prizes offered during the draw period. The odds of a player matching at least 3 numbers in a base game to qualify to receive a raffle ticket are determined by the base game.

In one embodiment, the fixed prize pool 712 and grand prize pool 722 are mutually exclusive. As depicted in the line defined as week 13 740, tickets sales for the add-on game of the present invention are lower than the previous week, as the grand prize was hypothetically paid out the week before. In this hypothetical draw period, although the gross add-on game ticket sales were only $2,814,096 with a weekly prize pool of only $1,407,048, the lottery was able to offer (1) $1,496,860 annuitized grand prize (3) $1 million fixed prizes, (12) $100,000 fixed prizes, (39) $10,000 prizes, and (279) $500 prizes, or a total of $6,226,360 in prizes in this drawing period. One benefit of mutually exclusive prize pools is to provide a consistent offering of prizes to players, a.k.a. “prize momentum”. In one embodiment, if a payout from either the grand prize pool 722 or the fixed prize pool 712 is equal to or greater than a pre-defined threshold in any particular drawing, leaving the prize pool deficient, a higher percentage of the prize pool 708 of subsequent drawings is allocated to the deficient prize pool(s) until said pool reaches a second pre-defined threshold. As an example, in the hypothetical week 13 740, $703,524 is allocated to the grand prize pool 722, and $703,524 is allocated to the fixed prize pool 712. Seeing that the grand prize pool 722 was completely paid out in the previous drawing, the present embodiment would allow for 100% of the prize pool 708 accumulated in week 13 740, or $1,407,048 to be allocated to the grand prize pool 722, and such allocation percentage would continue until the grand prize pool 722 reached or exceeded a pre-defined threshold, such as an amount needed to fund a guaranteed minimum grand prize. The benefit of said embodiment would be the opportunity to quickly accumulate a grand prize pool amount large enough to retain player interest and avoid fatigue.

FIG. 8 depicts a lottery game server process according to one embodiment of the present invention. The game server hosts a base on-line game or a raffle game, and includes a means for receiving a plurality of game entries, each game entry having at least one set of player indicia, a means for storing a prize table and a plurality of game entries; and a controlling means to carry out the functions below. The lottery authority receives a set of player indicia from at least one player with a first wager to play a lottery game 800, and an indication whether or not the player is purchasing the add-on game of the present invention for a second wager. The lottery authority generates a lottery ticket with a set of player indicia 802. In one embodiment, the authority also generates an indication if the add-on game was purchased. After the drawing, the lottery ticket is submitted to the lottery authority, who determines if the game play outcome qualifies the recipient to participate in a raffle drawing 804. If the game play outcome does not qualify the recipient to participate in a raffle drawing, the game is over for the player. If the game play outcome does qualify the recipient to participate in a raffle drawing, the lottery authority generates a raffle ticket with raffle indicia 806 and, in one embodiment, also generates an indication if the add-on game was purchased with the base game. After the raffle drawing, the raffle ticket is submitted to the lottery authority, who determines if the raffle ticket qualifies for a prize 808. If the raffle ticket does not qualify for a prize, the game is over for the player. If the raffle ticket qualifies for a prize, the lottery authority determines if the add-on game was purchased with the base game associated to the winning raffle ticket 810. If the add-on game was purchased with the base game associated to the winning raffle ticket, the lottery authority allocates the prize associated to the winning raffle ticket from the prize pool to the raffle ticket recipient 812. If the add-on game was not purchased with the base game associated to the winning raffle ticket, the lottery authority generates a QP lottery ticket with a set of player indicia for a subsequent drawing to be given to the raffle ticket recipient in lieu of the raffle prize 814, and allocates a percentage of the prize associated to the winning raffle ticket to a prize pool for subsequent drawings 816.

The controlling means is capable of (a) receiving a set of player indicia from at least one player 800, (b) generating a lottery game play with a set of player indicia 802, (c) determining if the lottery game play outcome qualifies the recipient to participate in a raffle game 804, (d) generating a raffle ticket with unique raffle indicia 806 (e) generating an indication if the add-on game was purchased with the base game 806, (e) determining if the raffle ticket indicia match any of the official winning indicia, thereby qualifying the recipient for a prize set 808, (f) determining if the add-on game was purchased with the base genie associated to the winning raffle ticket 810, (g) allocating the prize associated to the winning raffle ticket from the prize pool if the add-on game was purchased with the base game associated to the winning raffle ticket 812, and (h) generating a QP lottery ticket with a set of player indicia for a subsequent drawing 814 and/or allocating a percentage of the prize associated to the winning raffle ticket to a prize pool for subsequent drawings 816 if the add-on game was not purchased with the base game associated to the winning raffle ticket. In one embodiment, the controlling means is a computer readable medium on which is stored a computer program for playing on-line games and the raffle game of the present invention, the computer program comprising computer instructions that when executed by a computer perform the steps outlined herein.

FIG. 9. In one embodiment of the present invention, is a method for hosting the raffle game as an independent base game raffle drawing characterized in that a plurality of wagers can be paid for a single raffle game play, and unpaid prizes can be carried forward to subsequent raffle drawings. In this embodiment a raffle authority hosts a drawing where raffle game plays for a 1^{st} wager i.e. $20,00, and raffle game plays for a 2^{nd} wager, i.e. $10.00, are offered to a plurality of players for purchase to participate in a single raffle drawing, where the 1^{st} wager is larger than the 2^{nd} wager 900. Each raffle game play contains a unique raffle number or indicia that will automatically be entered into the following raffle drawing.

The player chooses a wager option and the raffle authority generates the raffle ticket with the unique raffle number and the wager or indicia associated to the wager paid for a raffle game play is printed on the raffle ticket 902. In one embodiment, multiple raffle number game plays are printed on a single raffle ticket. In one embodiment, the wager or indicia associated to the wager for each raffle game play is printed on the raffle ticket

The raffle drawing is held and the winning raffle numbers are identified 904. Prizes are awarded in the order drawn. Players submit their raffle game play tickets to the raffle authority 906, which makes a determination if their raffle number set matches the identified winning numbers 908. If their raffle number set does not match the identified winning numbers, the game is over for the player. If their raffle numbers do match any of the numbers selected as the official winning raffle numbers for the drawing, a determination is made whether the raffle game play was purchased for the 1^{st} wager or the 2^{nd} wager 910.

A first raffle prize or a second raffle prize is available to recipients whose raffle numbers match the official winning number(s) identified; depending on the wager the players paid for their raffle game tickets, where the 1^{st} prize is larger than the second prize. In one embodiment, the total amount of 1^{st} prizes offered in a single raffle drawing is equivalent to approximately 50% of the estimated ticket sales over the drawing period in addition to any unpaid prize money carried forward from previous raffle drawings and the total amount of the 2^{nd} prizes is less than the total amount of 1^{st} prizes.

If the raffle game play was purchased for the 1^{st} wager, the player receives an associated 1^{st} prize, i.e. $1,000,000 912. If the raffle game play was purchased for the 2^{nd} wager, the player receives an associated 2^{nd} prize, i.e. $100,000, where the 2^{nd} prize is less than the 1^{st} prize 914. If the 2^{nd} prize is awarded, an amount equal to the difference between the 1^{st} prize and the 2^{nd} prize, i.e. $900,000 rolls over to a subsequent drawing 916.

In one embodiment, there are “non-winning” raffle numbers or “non-winning units” entered into a raffle drawing for the purpose of offering unpredictability in a raffle prize payout. If a non-winning raffle number or non-winning unit is drawn, the prize associated to that particular draw is not awarded. In one embodiment, the unpaid prize rolls over to a subsequent drawing. In one embodiment, the number of “non-winning” raffle numbers or “non-winning units” entered into a drawing is associated to an unpredictable event, i.e., the number of winners who successfully achieve a pre-determined outcome, i.e. match 3 numbers, or the total number of plays in a base game.

Also provided is a lottery game server for hosting a raffle game according to one embodiment, of the present invention. The game server includes a means for receiving a plurality of raffle game plays, a means for storing a prize table and a plurality of game plays; each game play associated to a first wager amount and/or a second wager amount paid, and a controlling means.

The controlling means is capable of (a) receiving an indication of a first wager amount and/or a second wager amount to be associated to raffle game plays of a single raffle drawing, (b) generating a raffle ticket with a unique raffle number or raffle indicia and an indication of the wager amount paid for the raffle game play, (c) determining if the raffle game play qualifies for a prize, (d) determining if a winning raffle game play was purchased with a first wager amount or a second wager amount, (e) allocating a first prize associated to the winning raffle game play from a prize pool if the if the winning raffle game play was purchased with the first wager amount, (f) allocating a second prize associated to the winning raffle game play from a prize pool if the winning raffle game play was purchased with the second wager amount, and (g) allocating the difference between the first raffle prize and the second raffle prize, or a percentage of the difference to a prize pool for subsequent drawings if the if the winning raffle game play was purchased with a second wager amount. In one embodiment, the controlling means is a computer readable medium on which is stored a computer program for playing on-line games and the raffle game of the present invention, the computer program comprising computer instructions that when executed by a computer perform the steps outlined herein.

FIGS. 10 and 11 depict improvements to existing lottery games which can be offered to players for a premium wager which increases revenues for a lottery authority. These improvements, when applied to a base lottery game to which the add-on raffle game of the present invention is added to, provide an increased opportunity for players to experience a winning outcome, which allows more players to participate in the add-on raffle game of the present invention.

FIG. 10 depicts an improved base lottery game method which provides for a post-game modification feature for game play participants. In one embodiment, a lottery game play where a winner is determined through random selection or random symbol selection is offered for a wager 1000. The lottery authority receives player indicia, i.e. six lotto numbers, and a wager from a player 1002. In one embodiment, the lottery authority receives a request for a quick pick game play in lieu of receiving player indicia. The lottery authority generates a game play ticket with the set of player indicia 1004. The lottery authority holds a lottery drawing arid identifies the winning lottery indicia 1006.

Players submit their game play ticket to the lottery authority 1008, which makes a determination if the game play selection on their ticket, i.e. six lotto numbers, matches the winning outcome in the associated Lotto drawing 1010. If the complete game play selection (maximum-number of matches possible) on their ticket matches the numbers drawn as the winning outcome in the associated Lotto drawing—in any order—they are a jackpot winner and receive a jackpot or grand prize payout 1012. If the complete game play selection (maximum-number of matches possible) on their ticket do not all match the numbers drawn as the winning outcome in the associated Lotto drawing, the game play recipient can claim credit for modifying at least one non-matching number on their ticket by at least one integer after the drawing period, to enhance their winning outcome 1014, i.e. if one of the non-matching numbers on their lotto ticket was a “7”, the player would have the option to “modify that number”, or claim redeeming credit for having either an “8” or a “6” on their ticket in replacement of the “7”, after the drawing period, to enhance their winning outcome. The lottery authority makes a determination if the modified game play selection results in an increased benefit to the game play recipient 1016. If the modified number. i.e. “6 or 8” provides the recipient with an increased amount of matching numbers or provides the recipient with an increased benefit, the game play ticket will he redeemed and prize will be awarded as if the modified number is the valid number on the game play ticket 1018. If the modified number, i.e. “6 or 8” does not provide the recipient with an increased amount of matching numbers or does not provide the recipient with an increased benefit, the game play ticket will be redeemed or discarded as if there was no change to the ticket 1020. In one embodiment, the amount of non-matching numbers a player can modify or the amount of integers the player can modify numbers by is associated to the wager paid when they purchased their game play.

In one embodiment, the prize payout a ticket recipient receives with modified matching numbers is a reduced amount, i.e. half of the prize amount they would have received if they originally chose the modified numbers. In one embodiment, the player has the option of changing a plurality of symbols by a plurality of integers. In one embodiment, the post-game symbol-changing feature is only available if a premium or 2^{nd} wager was paid to play the game, i.e. $2.00. In one embodiment, prizes awarded as a result of the enhancing benefit is limited to pari-mutual prizes, or where the prize pool is divided evenly between all winners of a category, i.e. 3,4,5, or 6 matching numbers. In this embodiment, the enhancement feature would not be applicable for a player to claim a prize which would not have been paid out in the absence of the enhancement feature, i.e. changing a number to meet the minimum qualifications for a free ticket prize.

FIG. 11 depicts an improved base lottery game method which provides for a pre-game enhancement feature for game play participants. In one embodiment, a lottery game play where a winner is determined through random selection or random symbol selection is offered for a wager, characterized in that a player is provided the opportunity to select a higher amount of symbols to participate in the game than the maximum amount drawn in the lottery drawing, without changing the amount of matching symbols necessary to achieve a winning outcome, i.e. a player can select 8 lotto numbers instead of 6 lotto numbers 1100. In this example, the lottery authority receives the player indicia, the amount of which is greater than the maximum amount drawn in the lottery drawing, and the wager from a player 1102.

In one embodiment, the lottery authority receives a request for a quick pick game play in lieu of receiving player indicia, where the game indicia, the amount of which is greater than the maximum amount drawn in the lottery drawing, are randomly selected by the lottery authority. The lottery authority generates a game play ticket with the set of player indicia 1104. The lottery authority holds a lottery drawing and identifies the winning lottery indicia 1106.

Players submit their game play ticket to the lottery authority 1108, which makes a determination if any of the game play selection on their ticket, i.e. eight lotto numbers, matches the winning outcome in the associated Lotto drawing, i.e. six official winning numbers 1110. If the game play selection on the ticket matches a minimum amount of the official winning numbers to qualify for a prize as determined by the lottery authority. i.e. three or more matching numbers—in any order—the recipient is a winner and receives the associated prize payout 1112. If the game play selection on the ticket does not match a minimum amount of the official winning numbers to qualify for a prize as determined by the lottery authority. i.e. three or more matching numbers, the recipient is not a winner and the game is over 1114.

In one embodiment, a player has the option of selecting a plurality of additional symbols on a single game play to increase their chances of a winning outcome; the amount of additional symbols allowable is associated to the amount of the wager paid. In one embodiment, prizes awarded as a result of the game enhancing benefit are limited to pari-mutuel prizes, or where the prize pool is divided evenly between all winners of a category, i.e. 3,4,5, or 6 matching numbers. In this embodiment, the enhancement feature would not be applicable for a player to claim a prize which would not have been paid out in the absence of the enhancement feature, i.e. claiming the additional number(s) to meet the minimum qualifications for a free ticket prize.

FIG. 12. Depicts a ticket dispensing terminal interface 1200 for an express means for facilitating or distributing lottery game plays of the present invention and other on-line game plays hosted by the lottery authority through the use of an electronic lottery game network. The ticket dispensing terminal interface 1200 is provided as an automated game play dispensing apparatus which when combined with the methods herein, provides quicker transaction periods and assists players in “impulse game-play” transactions when strategically positioned, i.e. alongside a grocery store checkout line.

The ticket dispensing terminal interface 1200 consists of an external housing 1202 for access by a player, an input device means to identify or authenticate a player i.e. a keypad 1204 or interactive touch screen keypad which is on a GUI or LCD screen 1206 to receive a personal identification code (i.e. a PIN) or other game play input by a player and for displaying graphical game play communications or prizes of an upcoming drawing, a reading means 1208 to read a swiped credit card or issued identification card, a fingerprint swipe sensor 1210 or other biometric, reading means, a means to provide electrical power to the terminal i.e. a power cord connected to an electrical socket, a printing system 1216 whereby an on-line ticket substrate is fed into a thermal or other printing means to mark the ticket substrate with a player's game play set arid drawing information, a memory means 1218, a processor 1220 for controlling terminal operations, an input device for receiving player communication, comprising an arrangement including one or more input buttons, keys, switches or similar input receiving means, a storage means 1222 to store continuous feed ticket stock, at least one mounted dispensing unit 1224 operable to dispense game play tickets after being printed, a motion sensor detecting the presence or an action of a player, a conventional interface circuit design 1212 similar to those currently used in machines where lottery tickets are sold over the counter, a network means 1226 connecting the terminal to a central server or central processing system, a communication means whereby the terminal can transmit signals to and receive signals from a central server or central processing system associated to a player's request, and a computer program product including instructions embodied on a computer readable storage medium 1228, the computer program product acting to allow for receiving a player command, transmitting player data to a central processing system 1302, receiving commands from a central processing system 1302 and marking a lottery substrate with a user's game play indicia.

FIG. 13. Depicts a secure network relationship 1300 between a plurality of terminal interfaces 1200, a plurality of registration terminals 1304, at least one central processing system 1310 overseen by a central authority or lottery authority 1322, and at least one player financier 1306.

The player registration terminal 1304 is responsible for receiving and transmitting 1402 player registration data to a central processing system 1302, which upon receiving the data creates a new player record 1310, records the data in the record 1404 and provides a means for a unit of the player's identifying information to be searchable on a database or computer readable medium 1312, allowing the a player to be recognized through a plurality of ticket dispensing terminal interfaces 1200. A registration terminal 1304 in one embodiment is a lottery retailer where a lottery authority can verify the identity and age of a player during the registration process however may also be through an automated means as authentication technology progresses. In one embodiment, a player can register via a personal computer 1314, an interactive television 1326, cell phone and/or PDA 1324 connected to the internet. In one embodiment a final authentication or validation occurs at a player registration terminal 1304, i.e. a lottery retailer receives a username and password or identifying means for a profile already established by a player directly, verifies the player's age and identity, records the player's identifiable data, i.e. fingerprint or assigns a unique identifier to the player, and submits the data to the central processing system 1302 as a completed record. In one embodiment, a player can modify their player record 1310 through a ticket dispenser terminal interface 1200, through a personal computer 1314 connected to the internet or through other direct means. As part of the registration process, the following may be collected from a player, and is also referred to as player registration, player profile and player record hereunder:
a. Personal Information. The player's identity and age may be verified by the lottery retailer through a form of issued identification. The information collected may include user's name, address, phone number, email address; driver's license or issued identification number, date of birth, player signature, username or password.
b. Payment Information. Payment information is collected and recorded as an electronic means to pay for future game play requests. In one embodiment, the payment information may include a hank account number, bank routing number, debit card number, credit card number, Electronic Funds Transfer (EFT) data, ACH transfer data, gift card data, data for a backup secondary payment means, or data for an account set up specifically to transact electronic game play purchases. In one embodiment, the payment means will be tested during the registration process, i.e. a transaction for a nominal amount. In one embodiment, the player submits a signed authorization associated to the payment information which is included in the player's registration record.
c. Unique Identifying Information. Unique identifying information recorded may include a personal identification number, username, password, associating a unique swipe or electronically readable card to the user, issuing and associating an electronic device ID number, collecting biometric data from the user, such as a retinal scan, fingerprint data, or a combination thereof.
d. Game Play Preferences. The user selects preferences of “game play favorites” to be displayed on the terminal interface upon the lottery authority receiving and matching the player's unique identifying information from a terminal interface 1200. The game play preferences may include specific game play indicia, a request for quick pick indicia, an amount of game plays to be issued, specific game drawings to participate in, i.e. lotto, mega millions, or play 4, and add-on games to include. In one embodiment, a player can opt into a recurring auto-purchase of at least one game play. In one embodiment, a player can request their winnings to be automatically transferred to their bank account on record and their game play will be issued as a non-redeemable receipt. Game play preferences is also referred to as “pre-stored game play request” and “game play favorites” hereunder.

The ticket dispensing terminal interface 1200 is the primary interface between the central processing system 1302 and the registered player, and is responsible for receiving unique identifying information from a player, transmitting signals associated to the information to a central processing system 1302, displaying game play information 1316, including game preferences or favorites from a player's record 1310 transmitted by the central processing system 1302, receiving game play commands from a player, confirming game play actions, and marking and issuing game play tickets. In one embodiment, the ticket dispensing terminal interface 1200 provides for receiving a player registration or a modification of a player record 1310 and transmitting such data to a central processing system 1302. In one embodiment, the terminal interface is fitted with a payment receiving means and receives wagers associated to requested game plays. In the preferred embodiment, there is a plurality of terminal interfaces 1200 strategically placed throughout the domain of the lottery authority for easy player access.

The central processing system 1302 contains a network means for communicating and receiving player registration data from a plurality of registration terminals 1304, a network means for communicating and receiving unique identifying information representing game play requests from a plurality of players through a plurality of terminal interfaces 1200, a computer readable medium 1312 on which is stored a plurality of player records 1310, associated game play transactions and computer program for processing and administrating lottery game plays, the computer program comprising computer instructions that when executed by a computer perform the steps as defined hereunder, a record organization and access means which includes using the unique identifying information of a player to locate and access a player record 1310, a means to detect a cut-off time to discontinue processing game plays in specific drawings, access to a secure to gateway 1308 to communicate transactions to a player's financier 1320, i.e. bank or credit card issuer, and may consist of a plurality of networked processors.

The central processing system 1302 is responsible for servicing game play requests and coordinating the use of player records 1310 to identify game play requests, request and receive wagers via electronic means from players' pre-defined financiers 1320, confirm game play information 1316 with players, record player game play transactions and process the printing of game plays at various ticket distribution terminal interfaces 1200 on a network 1300.

FIGS. 14A&B depict an operational method for express distribution of game plays in one embodiment of the present invention. In the preferred method, a player first registers through a registration terminal 1304 as previously taught. The terminal transmits 1402 the player registration data to a central processing system 1302, which creates a new player record 1310, records the data in the record 1404.

If a player would like to participate in a periodic drawing, the player inputs their unique identifier, i.e. fingerprint swipe at the terminal interface 1200, 1406 which transmits the data to a central processing system 1310. The central processing system 1302 receives unique identifying information i.e. a fingerprint or retinal eye scan from the terminal interface 1200, and attempts to match the unique identifying information in a database 1312 of registered player records 1310, 1408. If matching information is not found, the central processing system 1310 responds through the terminal interface GUI 1206 with a reject message, i.e. “Player not found in our database. Please register at a registration terminal” 1412. In one embodiment, if a match is found 1410, the central processing system 1302 performs a quality control inspection to ensure a minimum amount of data needed for a transaction, i.e. game play request, client's financier data, etc. in player record 1310 is present 1414. If the player's record is not complete, the system 1302 responds through the terminal interface GUI 1206 with a reject message, i.e.”Player registration incomplete. Please register at a registration terminal” 1416. In one embodiment, the quality control check is done upon the completion of the player registration. In one embodiment, if matching identification is found, the central processing system 1302 accesses the player's record 1310, retrieves the player's game preferences 1316, i.e. “player favorites” including selected games, specific game indicia, amount of game plays, add-on games, and the total wager for the request, and transmits a signal representing the game play choices to the player for purchase confirmation 1418. Once received, the data is displayed on the terminal interface 1200, 1420 and the player is prompted for a response. In one embodiment, the graphical information also includes the player's name with an option to prompt the interface 1200 if the name or game play data is incorrect. In one embodiment, the request times out and is deleted after a period of non-activity if a player does not respond on the terminal interface 1200 within a pre-determined amount of time during the transaction request. In one embodiment, the player is provided the option to reply by confirming the displayed game play request through input on the terminal interface 1200, or by selecting or deselecting displayed favorite game plays for purchase displayed as contained in their client record 1422. In one embodiment, a code name for the player's payment means is recorded upon registration, i.e. “John's checking account” and is provided on the confirmation screen 1206 as a reminder to the player where the transaction financing request will be sent. In one embodiment, the player has a plurality of payment means recorded and is provided the option of selecting one for the game play purchase. In one embodiment, the player is provided the opportunity to pay a game play wager at the terminal. In one embodiment, a player is provided an opportunity to add game play indicia and create game play requests through the terminal interface 1200 to be added to their permanent player record 1310.

If the player confirms the request to purchase through the terminal interface 1200 i.e. selecting or deselecting specific game plays, add-on games or prompting to buy, print, or continue, a signal representing the final request is transmitted to the central processing system 1302, which totals the wager for the requested game plays and submits the transaction through a secure payment gateway 1308 to the player's financier 1306 i.e. bank, debit card issuer, credit card issuer, lottery game play account or financier as indicated in the player's record 1310, 1426. In one embodiment, if the player requests an edit to the displayed game information, i.e. a change in game plays to purchase, a change in game indicia or game add-on options, the change is first recorded in the player's record 1310, then is submitted to the player's bank or financier 1306, 1424. In one embodiment, the player has the option to limit the change to the transaction or to make the change permanent in the player record, which will recall the change for all future play requests.

The players bank or financier 1306 as indicated in the player's record 1310 receives the transaction request 1428, and either approves or disapproves the transaction 1430 based on the available funds in the player's account 1320 and passes the transaction results to the central processing system 1302. If approved, the bank or financier transmits approval notice and approved funds 1438 back through a SSL means or similar secure gateway 1308 to an account 1318 associated to the central processing system 1302 or affiliated with the central authority 1322, where the central authority 1322 is the entity which holds authority over the central processing system 1302 and/or game administration. In one embodiment, the central processing system 1302 receives an immediate transaction reply and if approved, appropriate funds through a conventional method commonly used in transaction processing where the funds may be received by the central authority after the approval notice is received and after the completion of the game play transaction is approved. In one embodiment, a 3^{rd} party processing system, such as www.authorize.net is contracted to process player transactions. In such an embodiment, wagers for game plays would be retrieved and reported from player financiers using methods conventionally known in the art of 3^{rd} party payment processing.

If the central processing system 1302 receives indication that the transaction is declined 1432, the processing system 1302 communicates this status 1434 to the player through the terminal interface 1200. i.e. “Transaction was not approved by your banking institution” and the transaction request is over 1436. If the central processing system 1302 receives indication that the transaction is approved 1440, the central processing system records the transaction 1442 as associated to the player record 1310 wherein the game play indicia are associated to the player for the corresponding drawing, and the central processing system 1310 communicates approval information associated to the player's game play request to the terminal interface 1200 along with a command to print the associated game plays 1444. The terminal interface 1200 displays an indication of a successful transaction, i.e. “Your request has been approved by your banking institution” and prints the requested on-line game plays for the player 1446 and the transaction is complete. In one embodiment, a player's signature is retrieved from their record 1310 and is printed on the back of their game play ticket. In one embodiment, non-redeemable transaction receipts are printed in lieu of game play tickets, where winning prize amounts are transferred to the players account electronically. In one embodiment, the central processing system 1302 or an affiliation thereof generates an email which is sent to the email address in the player's record 1310 informing them of the transaction or transaction attempt. In one embodiment, the email contains the details of the transaction, status of the request, terminal interface 1200 location, game play numbers, drawing date and time or a transaction receipt. In one embodiment, the game play transaction is associated to the player in an official capacity, i.e. if a player loses a game play ticket, the central aka lottery authority 1322 will rely on its own transcript of the transaction to determine the owner of the winning game play. In one embodiment, the central authority 1322 notifies a player of the winning indicia of a drawing they participated in, and electronically inform the player of their outcome, i.e. “YOU WON!!! You had 3 matching numbers, 07, 14 and 43 for a redeemable prize of $9.05”. In one embodiment, a player can request all cash prizes to be automatically transferred to their financier 1306 listed in their profile or to another account for this purpose. In one embodiment, the central lottery authority 1322 receives a transaction fee or subscription fee for performing these services.

In one embodiment, the lottery authority 1322 pays a fixed rental fee to a retailer to position the terminal interface 1200 in the retailer's business in lieu of paying the retailer a percentage of game play sales. In one embodiment the lottery authority 1322 pays a fixed rental fee combined with a reduced percentage of game play sales to position the terminal interface 1200 in the retailer's business. In one embodiment, the lottery authority 1322 offers a free game play to players as an enticement to become a registered player.

In one embodiment, the terminal interface 1200 is a player's cell phone or PDA 1324, personal computer 1314, or interactive television 1326, where a player record 1310 is accessed through a Internet website or network means with a username, password, unique identifier issued to the player or associated to the player's personal terminal interface 1314, 1324, 1326, where the purchased game play is associated to the player electronically, and a non-redeemable electronic receipt is generated in lieu of a game play ticket. If the player achieves a winning outcome, the winning proceeds are electronically transferred to the player's account 1320 at the financier 1306 or an account 1320 in the player record 1310 as previously taught.

Therefore, the foregoing is considered as illustrative only of the principles of the invention. Further, since numerous modifications and changes will readily occur to those skilled in the art, it is not desired to limit the invention to the exact steps shown and described, and accordingly, all suitable modifications, steps, combinations of steps, features and equivalents that may be resorted to, in order to provide an add-on raffle game fall within the scope of the invention.

It is appreciated that not every implementation will necessarily embody all or even most of the specific embodiments, details and extensions discussed above in relation to the basic method. The games, methods and systems are described in the above manner to reduce the need for external reference when attempting to understand the context in which the alternative embodiments and aspects of the present invention operate. For that matter, it is to be appreciated that all embodiments taught are applicable to all games, methods and systems presented herein, and fall within the scope of the invention.

Should any provision of this patent be void or unenforceable for any reason, such provision shall be deemed omitted and this patent with such provision omitted shall remain in full force and effect.

### BRIEF DESCRIPTION OF DRAWINGS

This invention may be embodied in the form illustrated in the accompanying drawings, attention being called to the fact, however, that the drawings are illustrative only, and that changes may be made in the specific construction illustrated.

Various other objects, features and attendant advantages of the present invention will become fully appreciated as the same becomes better understood when considered in conjunction with the accompanying drawings.

FIGS. 1A&B depict the premise of hosting the add-on raffle game, according to one embodiment of the present invention;

FIG. 2 is a table depicting the data of raffles currently offered by state lotteries throughout the United States;

FIG. 3 is a table depicting the relationship between the average jackpot size and the corresponding amount of ticket sales based on 2006 data published by the Florida Lotto game;

FIG. 4 depicts a plan front view of a lotto ticket and raffle ticket incorporating the raffle game of the present invention;

FIG. 6 is a chart depicting the allocation of the prize pool in one embodiment of the present invention;

FIG. 7 is a table depicting a model of the add-on game of the present invention if applied to the Florida lottery jackpot games based on 2006 data published by the Florida lottery;

FIGS. 8A&B depict a lottery game server process according to one embodiment of the present invention.

FIG. 9 depicts the premise of independent rolling raffle base game, according to one embodiment of the present invention.

FIGS. 10A&B depict a schematic block diagram depicting a base gaming segment with post-game symbol modification features according to one embodiment of the present invention;

FIG. 11 depicts a schematic block diagram depicting a base game of chance with a pre-game enhanced odds feature according to one embodiment of the present invention.

FIG. 12 depict a ticket dispensing terminal interface for an express means for dispensing lottery game plays of the present invention and other on-line game plays hosted by the lottery authority.

FIG. 13 depicts a secure network relationship between a plurality of terminal interfaces, a plurality of registration terminals, at least one central processing system overseen by a central authority or lottery authority, and at least one player financier.

FIGS. 14A&B depict an operational method for express distribution of game plays in one embodiment of the present invention.

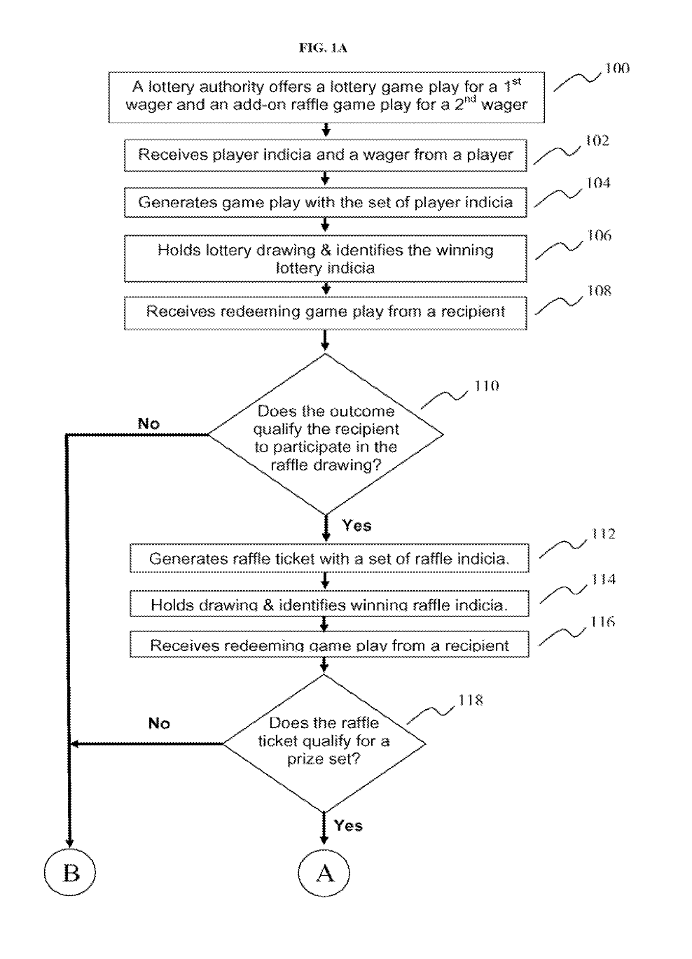

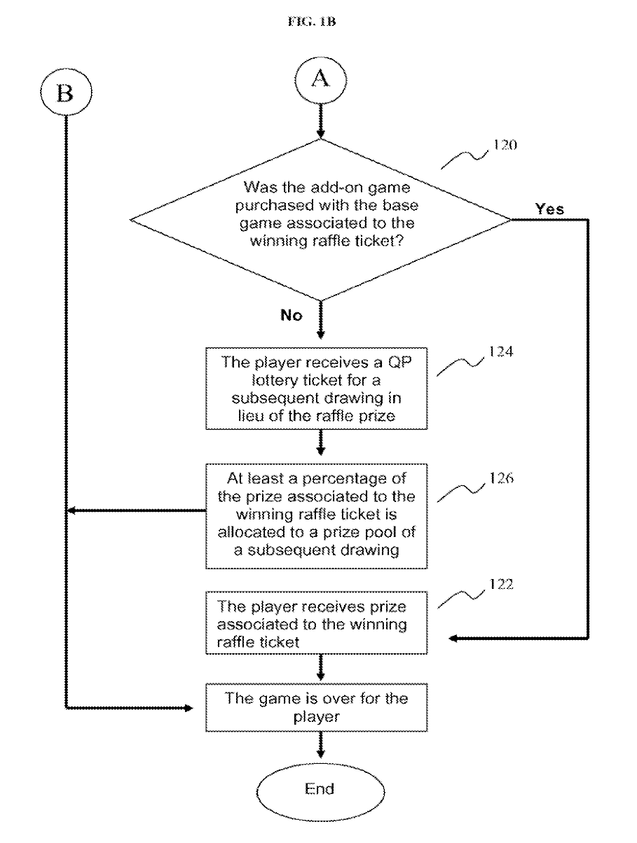

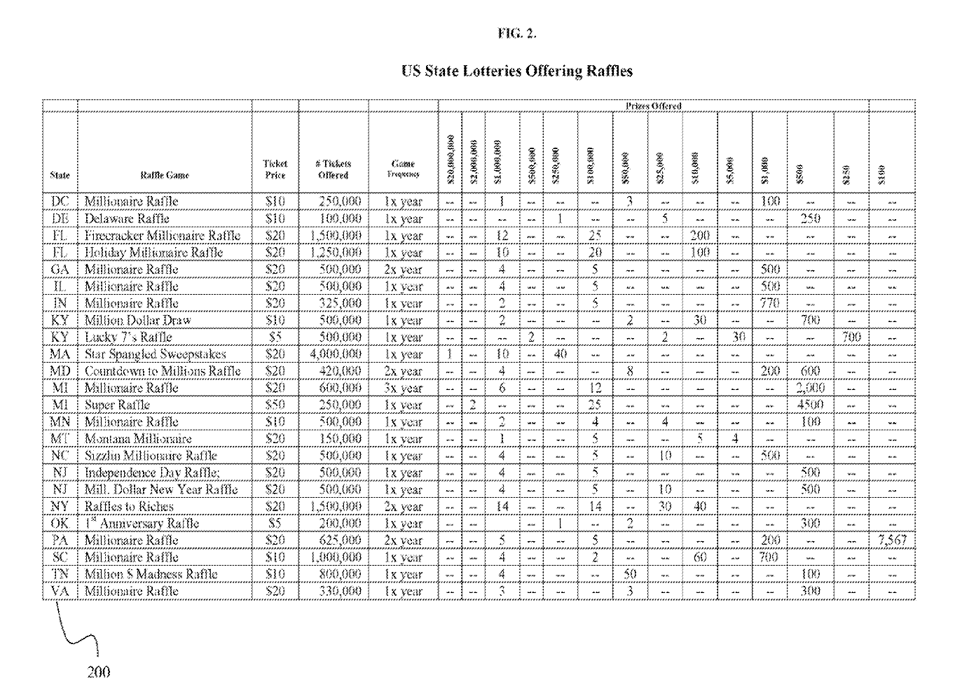

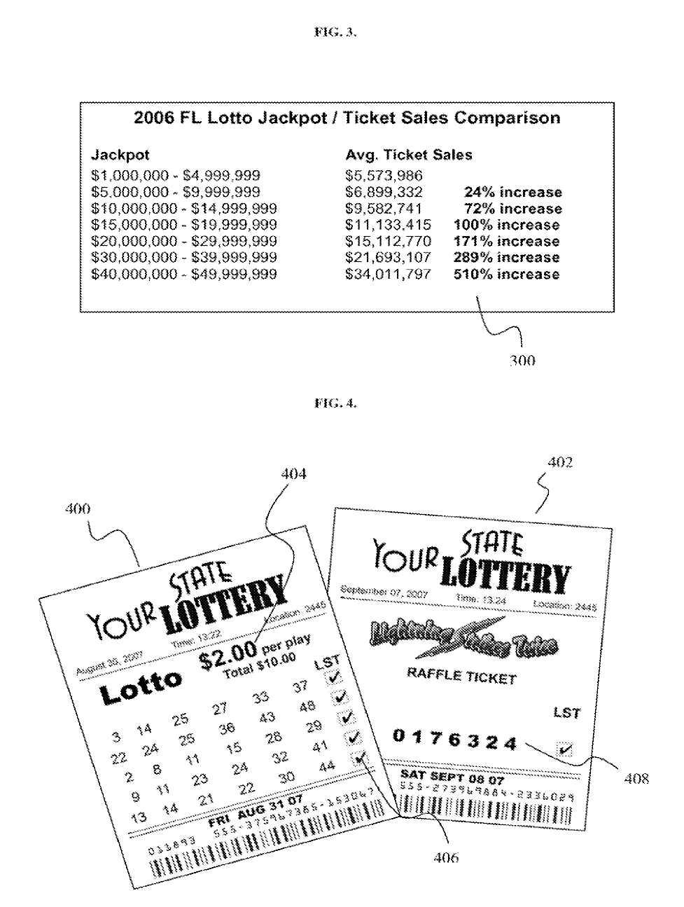

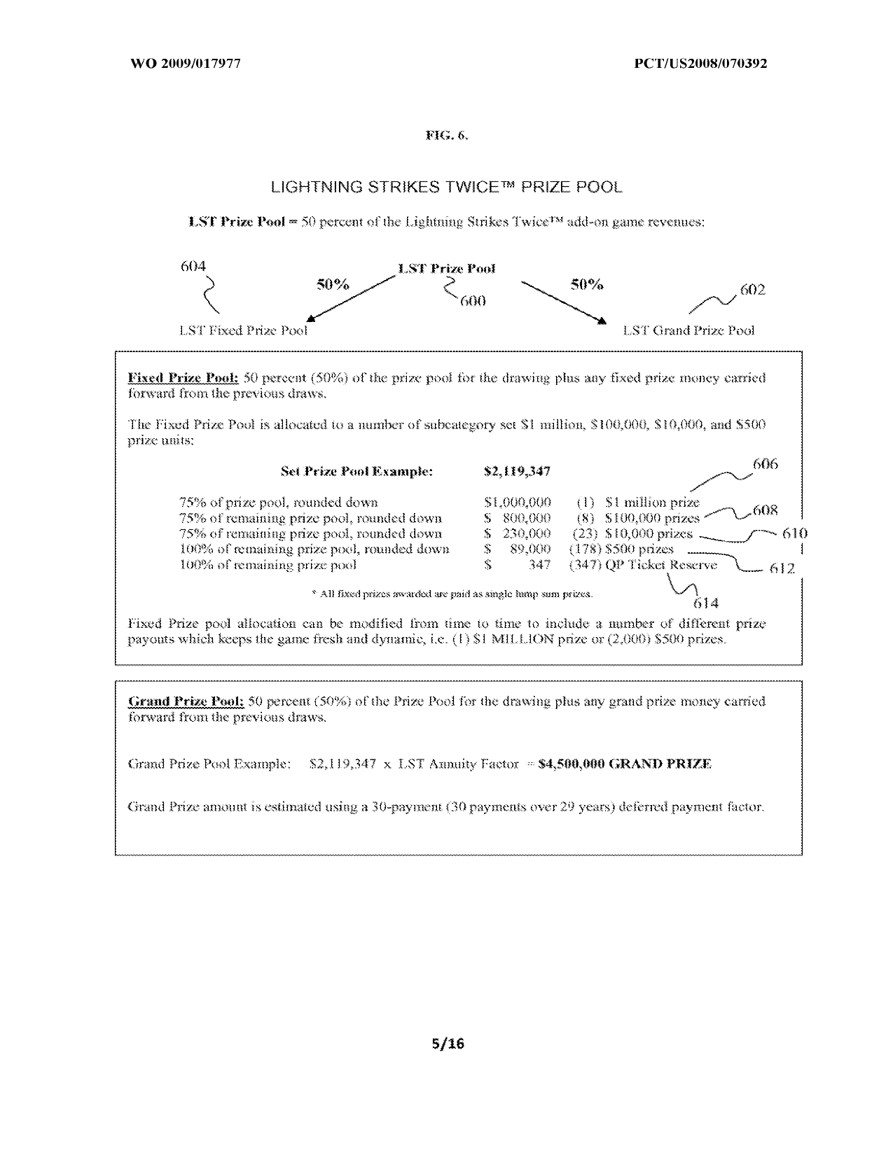

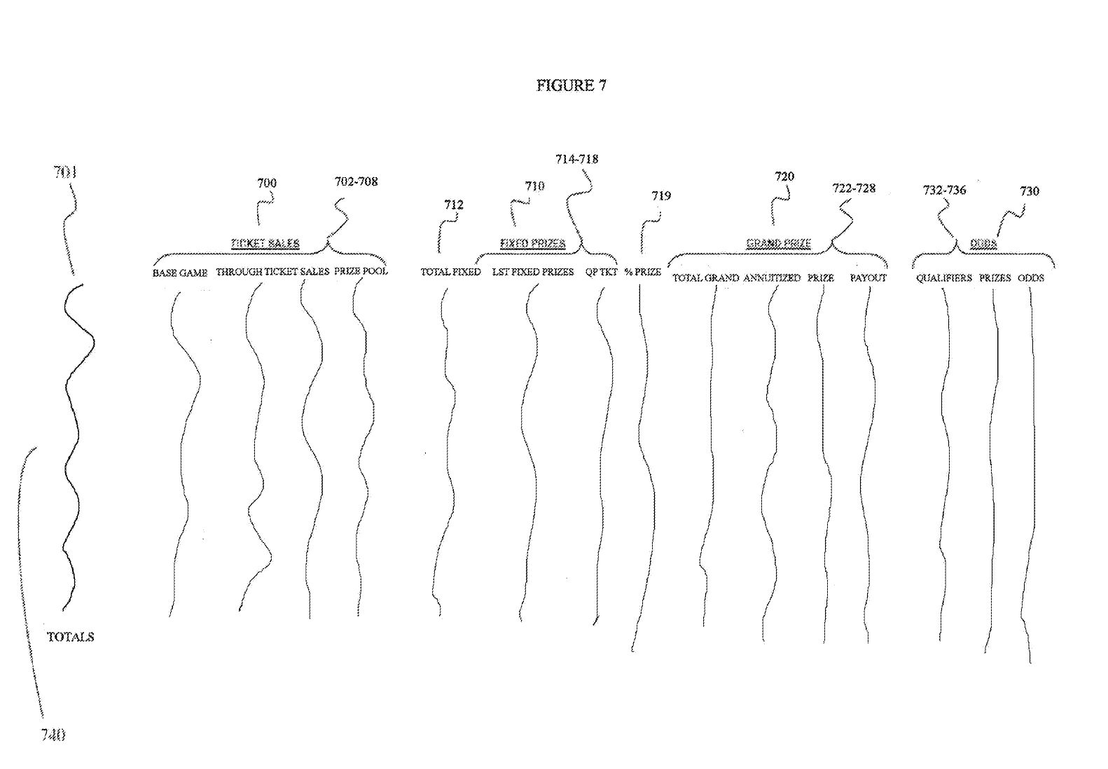

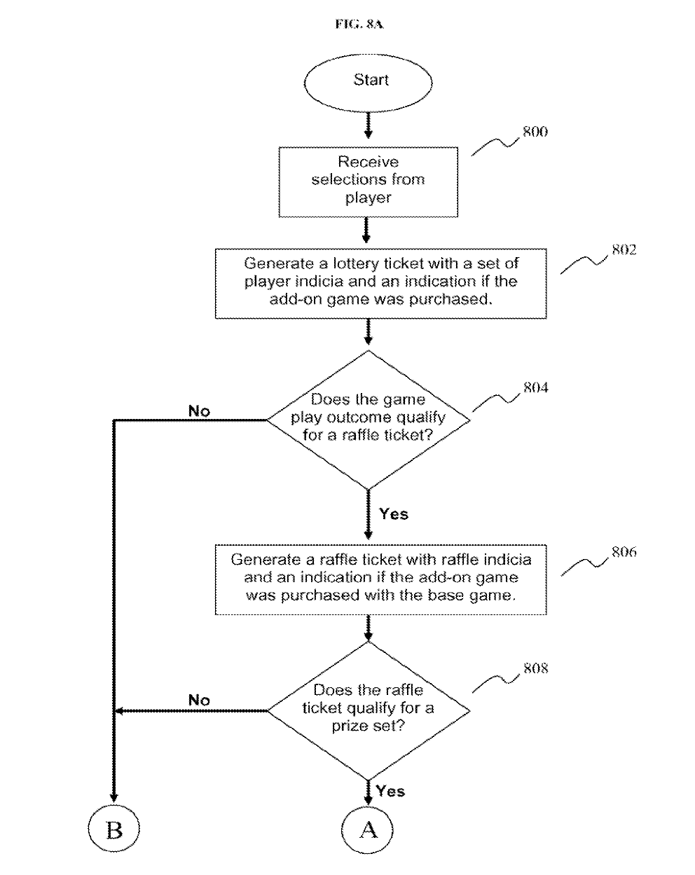

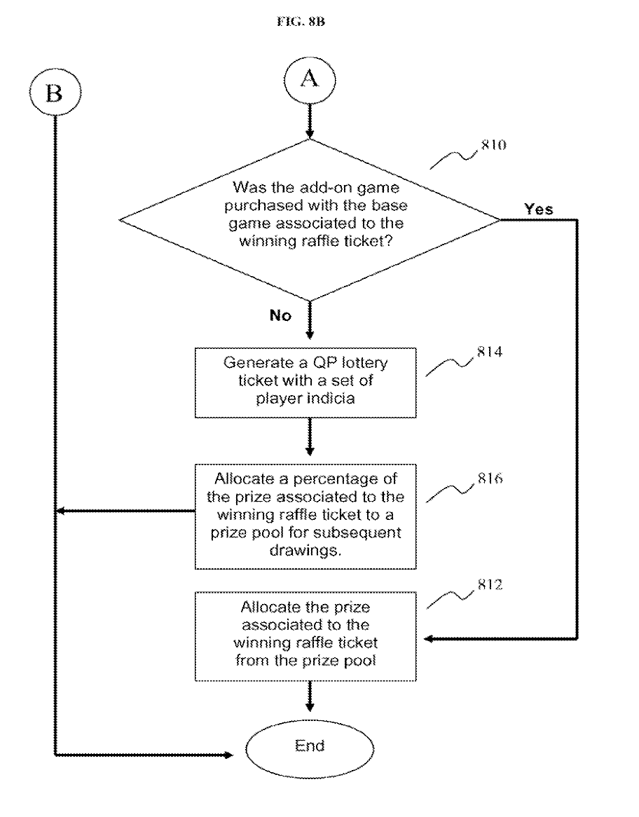

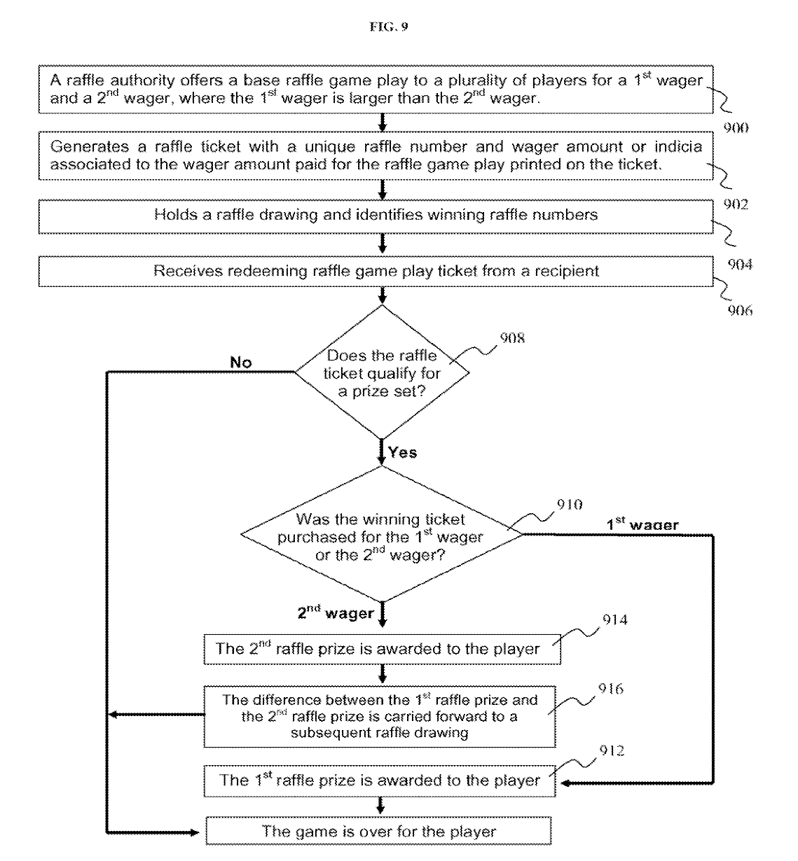

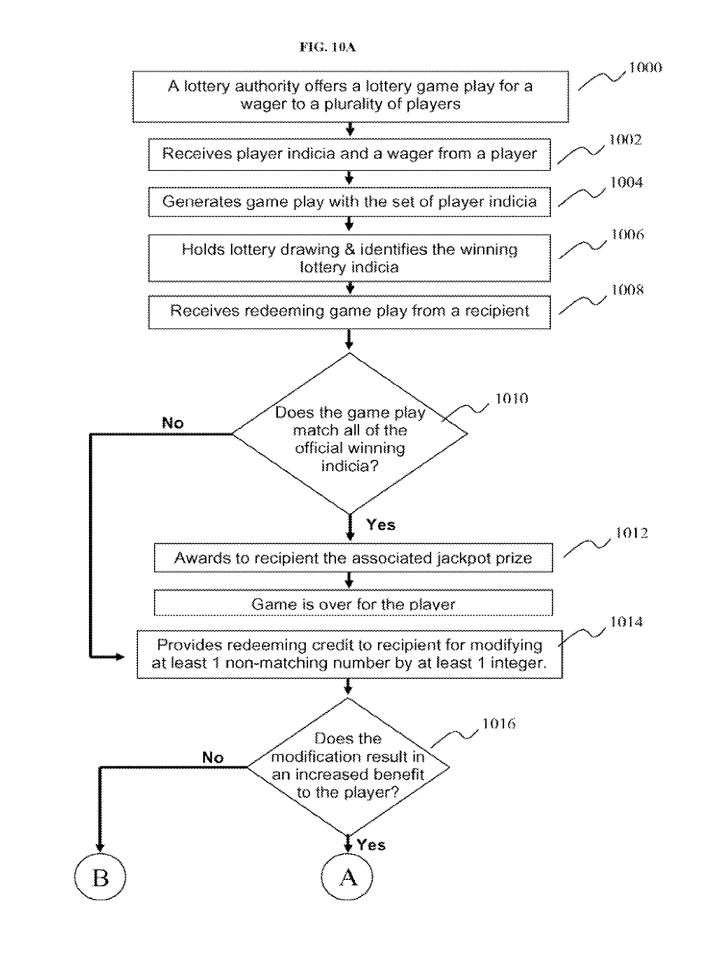

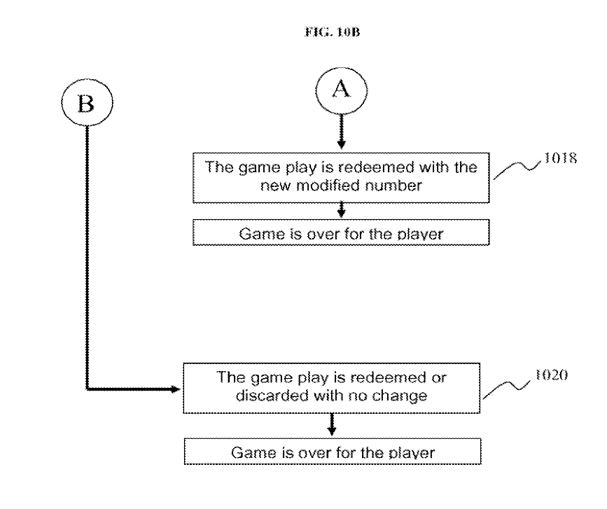

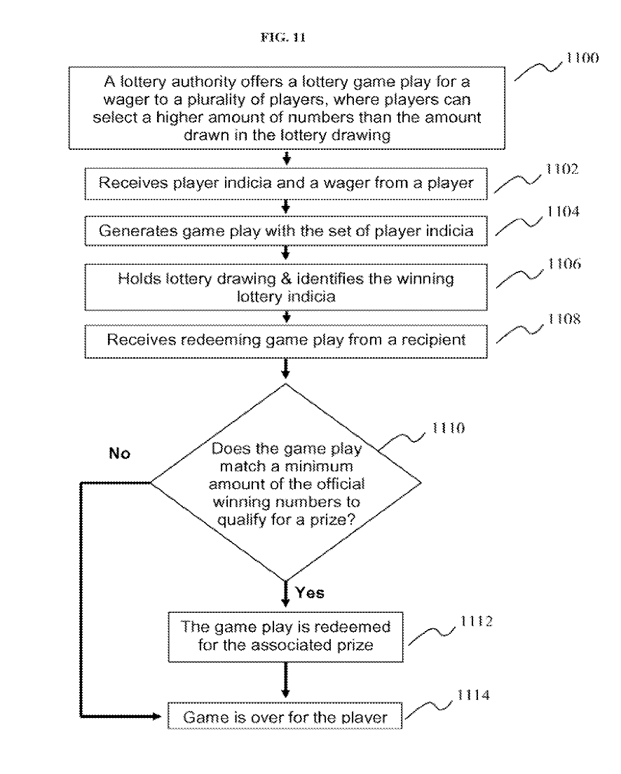

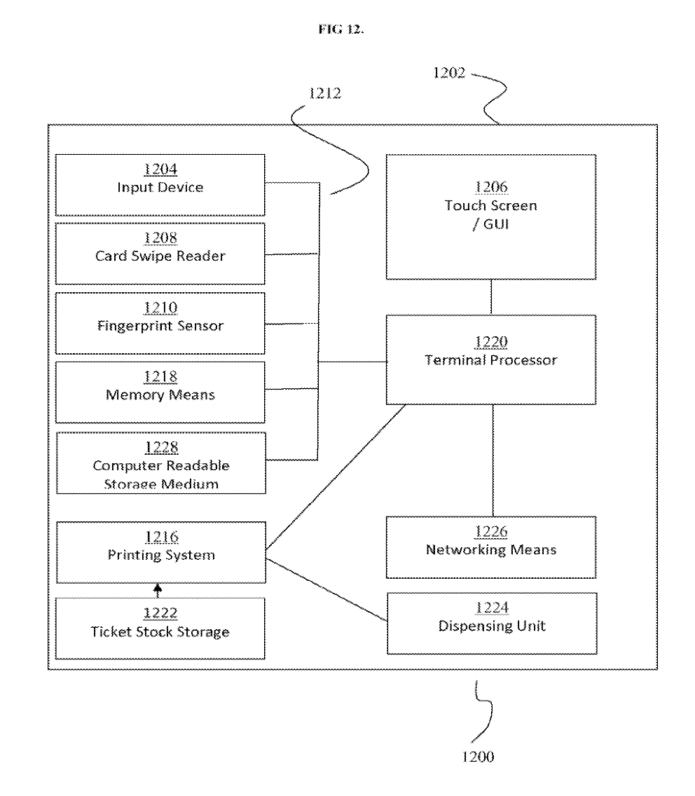

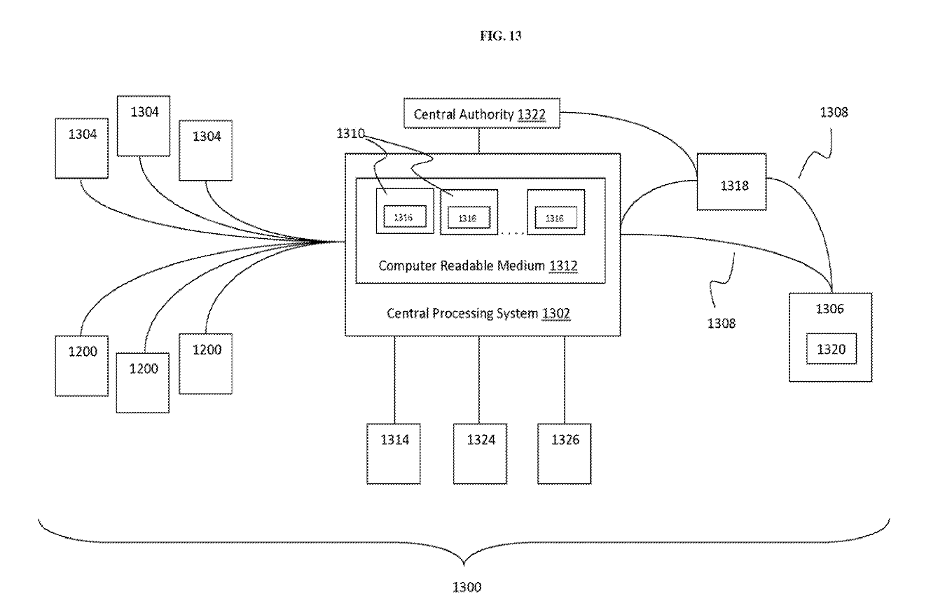

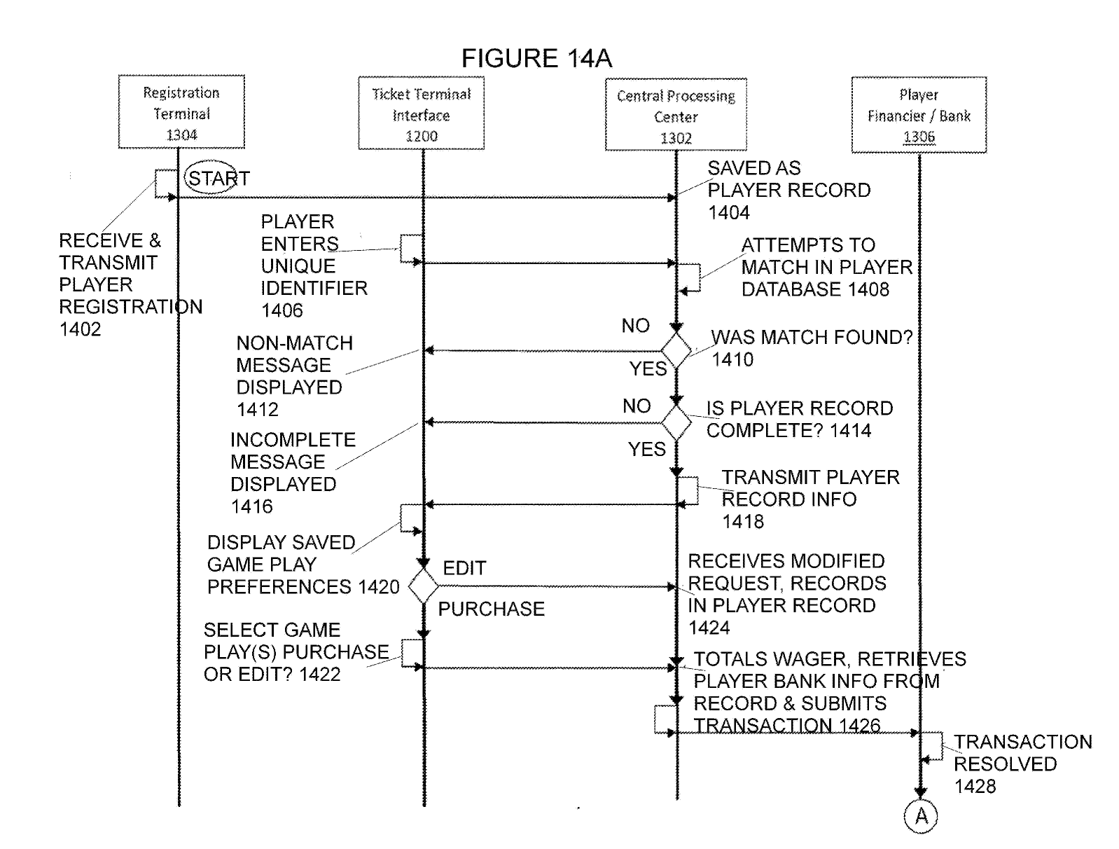

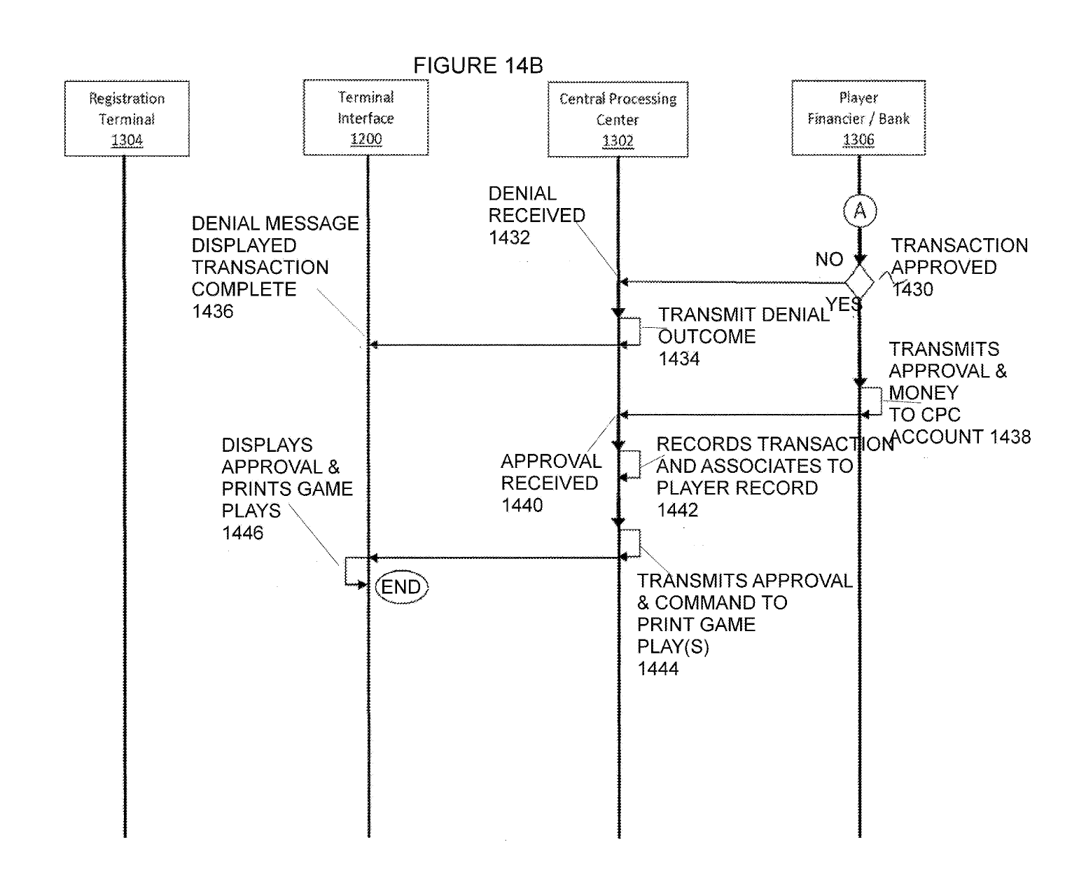

### BEST MODE FOR CARRYING OUT THE INVENTION

Suggested Game Rules. The following are suggested game rules for the add-on raffle game embodiment of the present invention. The rules are presented as one embodiment of the present invention, and should not be viewed as fixed or limiting,

I. Purpose

These rules establish the procedures and requirements for playing the Lightning Strikes Twice™ game, a lottery add-on game operated by the . . . State/Federal Lottery.

II. Definitions

The following definitions apply unless the context requires a different meaning.

(1) “Base Game Play” means a single game play of a Lottery jackpot game that permits the Lightning Strikes Twice™ add-on game.

(2) “Drawing” means the formal process of selecting winning numbers which determine the winners for each prize level of the game.

(3) “Fixed Prize” means all prizes of a guaranteed amount withstanding the Grand Prize that are advertised to be paid by a single lump sum payment and, except in instances outlined in these rules, will be equal to the prize amount established by the Lottery for the prize level.

(4) “Fixed Prize Pool” means the portion of the Prize Pool set aside for the payment of the Fixed Prizes. The Fixed Prize Pool for any drawing is expected to be 50% of the Prize Pool plus any fixed prize money carried forward from previous draws, but may be higher or lower based upon the funding required to meet the advertised Fixed Prizes.

(5) “Game Ticket” or “Ticket” means a valid ticket produced by a terminal which contains one or more lettered game plays along with the drawing date, the price of the ticket, a retailer number and a serial number that is compatible with the Lottery's online operating system transaction log.

(6) “Grand Prize” means the top prize in the Lightning Strikes Twice™ game which is determined on a pari-mutuel basis and may be paid by a single lump sum payment or by annual installments,

(7) “Grand Prize Pool” means the portion of the Prize Pool set aside for the payment of the Grand Prize. The Grand Prize Pool for any drawing is expected to be 50% of the Prize Pool plus any unpaid grand prize money carried forward from previous draws, but may be higher or lower based upon the funding required to meet the advertised Grand Prize.

(8) “Jackpot Game” means a state lottery game in which a pari-mutuel jackpot can be won.

(9) “Lightning Strikes Twice”' annuity prize” means the amount in the Grand Prize pool is multiplied by the market rate annuity factor to calculate the total Grand Prize payout amount to be paid annually in thirty equal payments. The annuity factor is the rate determined at market bid, given the amount to be invested on behalf of the prize winner over the full term of the life of the annuity.

(10) “Lightning Strikes Twice™ Raffle Ticket” or “Raffle Ticket” means a raffle ticket produced by a terminal which contains a single unique ticket number, the drawing date, an indicator if the Lightning Strikes Twice™ add-on game was purchased with the winning base game play, a retailer number and a serial number that is compatible with the bet file and validation record on the Lottery's online operating system.

(11) “Lottery” means the . . . State or Federal Lottery.

(12) “Official Winning Numbers” or “Winning Numbers” means the numbers randomly selected by the Lottery as the winning numbers in a single drawing, certified and entered into the online lottery system, which shall be used to determine winning plays contained on a game ticket or raffle ticket.

(13) “Prize Level” means the total amount of sales allocated to pay prize Claimants, at the designated prize level.

(14) “Play” or “Game Play” means the five or six numbers required to play in a single Lottery jackpot game drawing, which appear on a ticket as a single lettered selection and are to be played by a player in the game.

(15) “Play Slip” or “Game Slip” means the paper used in marking a player's game plays and containing one or more boards (complete “play combinations”.

(16) “Owner” means the bearer of a game ticket or raffle ticket before or after a signature is placed in the area designated for signature. The “player is the one purchasing or holding the ticket at the time of the drawing”.

(17) “Prize Pool” means the portion of the Lightning Strikes Twice™ gross sales set aside for the payment of prizes. The prize pool for any drawing is expected to be 50% of sales, but may be higher or lower based upon the number of winners at fixed prize levels, as well as the funding required to meet the advertised Grand Prize.

(18) “QP Lottery Ticket” means a quick pick lottery ticket with the numbers selected randomly by the lottery system not the player.

(19) “Qualifying Base Game Play” means matching at least 3 of the official winning numbers in a single game play line of a Lottery jackpot game, which qualifies a player for a single Lightning Strikes Twice™ raffle ticket.

(20) “Raffle Drawing” means a random computerized drawing from among all raffle ticket numbers issued during the sales period.

(21) “Retailer” means a person or entity authorized by the Lottery to sell lottery tickets.

III. Ticket Price

(1) A Lightning Strikes Twice™ add-on game shall cost one dollar (USA $1) per play or another amount determined by the Lottery.

(2) An offer to buy and an offer to sell a Lightning Strikes Twice™ add-on game shall be made only at a location which has a retailer contract with the Lottery or only by a method which is approved by the Lottery.

(3) The Lottery shall not directly and knowingly sell a Lightning Strikes Twice™ add-on game to any person or entity where said purchaser is guaranteed to win a Grand Prize.

IV. Game Description

(1) Lightning Strikes Twice™ is a progressive raffle add-on game which can be added at the time of purchase to one of the following State Lottery games that offers a Jackpot Prize. The Lightning Strikes Twice™ add-on game offers players who match at least 3 of the official winning numbers in a base jackpot game the opportunity to participate in a progressive raffle draw which offers a number of fixed cash prizes and a pari-mutuel Grand Prize.

(2) Upon redeeming a winning lottery game play which matches at least 3 of the official winning numbers in a base jackpot game, a player will receive a Lightning Strikes Twice™ raffle ticket containing a unique ticket number that will automatically be entered into the following Lightning Strikes Twice™ raffle drawing at no additional cost to the player. Each Lightning Strikes Twice™ raffle ticket contains only one ticket number and will automatically print from the terminal with ticket numbers issued in sequential order as associated winning game plays are redeemed around the state. Players cannot select their own ticket numbers. Each Lightning Strikes Twice™ raffle ticket indicates whether or not the Player purchased the Lightning Strikes Twice™ add-on game during the initial purchase of their associated winning game play. Players who redeem associated winning game plays past the weekly specified cut-off period will receive a Lightning Strikes Twice™ raffle ticket for the next following draw.

(3) It is the sole responsibility of the player to verify the accuracy of the original game play or plays, the indicator for whether or not they purchased the Lightning Strikes Twice™ add-on game to the original game play or plays, and other data printed on the ticket. A Raffle Ticket may not be voided or canceled by returning the ticket to the retailer or to the Lottery, including tickets that are printed in error. No ticket shall be returned to the Lottery for credit. The placing of plays is done at the player's own risk through the online retailer.

(4) The Lightning Strikes Twice™ Raffle Drawing is held every . . . at approximately . . . pm, E.T., and offers a number of fixed cash prizes and a pari-mutuel grand prize to players with matching numbers. Each Lightning Strikes Twice™ Raffle drawing shall be conducted with appropriate security and audit oversight and policies. A total of one Grand Prize and a multiple of Fixed Prizes, based on the amount available in the Fixed Prize Pool as allocated according to the rules in Section VII. (7) will be awarded. Prizes will be awarded in the order drawn. The first number drawn will win the Grand Prize. The following numbers drawn equal to the published amount of $1 million prizes offered in the drawing will win $1 million. The following numbers drawn equal to the published amount of $100,000 prizes offered in the drawing will win $100,000. The following numbers drawn equal to the published amount of $10,000 prizes offered in the drawing will win $10,000. The following numbers drawn equal to the published amount of $500 prizes offered in the drawing will win $500.

(5) To be eligible to receive the cash prize associated to an official winning Raffle ticket, a player must have purchased the Lightning Strikes Twice™ add-on game at the time the base game play was purchased. If the Owner of an official winning Raffle Ticket did not purchase the Lightning Strikes Twice™ add-on game at the time the base game play was purchased, the owner will receive a free QP lottery ticket in lieu of the associated cash prize. The cash prize associated to the winning Raffle ticket will not be awarded and will rollover to the subsequent Lightning Strikes Twice™ Raffle Drawing.

(6) The results of each drawing will be revealed each . . . at approximately . . . pm on the Lottery's Web site, by phone or at a lottery retailer.

V. Prize Claims

(1) Winning Lightning Strikes Twice™ Raffle tickets must be presented to a Lottery office for payment. The number on a raffle ticket must match the winning number drawn in EXACT ORDER. Tickets winning a free QP lottery ticket can be redeemed at any authorized Lottery retailer. Tickets winning $1 million or more must be submitted for payment at the Lottery Headquarters. Information about procedures for filing a claim can be obtained by calling Lottery Headquarters. Lightning Strikes Twice™ Raffle tickets are the only valid receipts to redeem a prize.

(2) Lightning Strikes Twice™ Raffle tickets must be validated within . . . days from the date of the drawing. If the prize is not paid at the time of validation, the player must submit the winning ticket for payment at any Lottery prize claim office, as required by the Lottery's rules governing the payment of prizes.

(3) If a winning Lightning Strikes Twice™ Raffle ticket bearing any of the winning numbers associated to a fixed prize or grand prize is not submitted for validation and payment in accordance with the Lottery's rule governing payment of prizes, the associated prize will not be awarded and will rollover to the subsequent Lightning Strikes Twice™ Raffle Drawing.

(4) Lightning Strikes Twice™ Raffle tickets shall be disqualified if any part of the ticket is illegible, altered, mutilated, tampered with or duplicated. A play slip or a copy of a Lightning Strikes Twice™ Raffle ticket has no pecuniary or prize value and does not constitute evidence of any ticket purchase.

(5) Players and prize claimants must be at least . . . years of age. Persons prohibited by State Statutes from purchasing a Lottery ticket are not eligible to play.

(6) All Lightning Strikes Twice™ Raffle prizes are subject to the provisions of State Statutes, and rules promulgated thereunder, including the official Lightning Strikes Twice™ Raffle rule. Prizes will be paid in accordance with the rules of the Lottery governing payment of prizes. Copies of the current prize payment rule and the Lightning Strikes Twice™ Raffle rule can be obtained from the Lottery.

(7) Payment of all federal, state and/or local taxes will be the responsibility of the winner. Federal withholding taxes will be deducted from the cash payment for prize amounts for which withholding is required by IRS Regulations.

(8) By purchasing a ticket and claiming a prize, winners grant the Lottery the right to use winners' Name, City, County and State of residence, prize amount and photograph or likeness to advertise and promote games or goodwill for the Lottery.

VI. Prize Pool

(1) The prize pool is allocated to a number of fixed prizes and a pari-mutuel grand prize, and shall consist of 50 percent (50%) of each Lightning Strikes Twice™ drawing period's sales, including tax, that remain after funding the Prize Reserve Accounts to the amounts established by the Lottery. Any amount remaining in the Prize Pool at the end of this genie shall be carried forward to a replacement game or expended in a manner as directed by the Lottery in accordance with state law.

(2) Two percent of sales, including tax, shall be placed in trust in one or more Prize Reserve Accounts until the Prize Reserve Accounts reach the amounts designated by the Lottery. Once the Prize Reserve Accounts exceed the designated amounts, the excess shall become part of the Prize Pool. Any amount remaining in a Prize Reserve Account at the end of this game shall be carried forward to a replacement Prize Reserve Account or expended in a manner as directed by the Lottery in accordance with state law.

(3) The Prize Pool shall be allocated as provided below.

(4) The Grand Prize Pool shall consist of 50 percent (50%) of the Prize Pool for the drawing plus any unpaid grand prize money carried forward from the previous draws. If the grand prize winner in a drawing did not purchase the Lightning Strikes Twice™ add-on game at the time the base game play was purchased, the winner will receive a free QP lottery ticket in lieu of the associated grand prize. The grand prize amount allocated to that winning raffle ticket will not be awarded and shall be carried over and added to the Grand Prize Pool of the subsequent Lightning Strikes Twice™ drawing.

(5) The Lottery may offer guaranteed minimum Grand Prize amounts or minimum increases in the Grand Prize amount between drawings or make other changes in the allocation of prize money where the Lottery finds that it would be in the best interest of the game. If a minimum Grand Prize amount or a minimum increase in the Grand Prize amount between drawings is offered by the Lottery, then the Prize Pool percentage allocated to the Grand Prize in subsequent drawings shalt be increased to 100 percent (100%) until the amount accumulated in the Grand Prize pool, as determined by the Lottery, is sufficient to fund the minimum Grand Prize amount or a minimum increase in the Grand Prize amount between drawings, with the remainder in a given drawing period funding the Fixed Prize Pool.

(6) If the total of the Grand Prize awarded in a drawing exceeds the amount in the Grand Prize pool allocated to the Grand Prize, then the amount needed to fund the Grand Prize awarded shall be drawn from the following sources, in the following order:

(A) The amount allocated to unpaid fixed prizes that is carrying forward to a subsequent draw, if any;

(B) An amount from the Prize Reserve Account, if available, not to exceed $ . . . ,000,000 per drawing;

(C) The amount allocated to fixed prize payouts for the drawing;

(D) If, after these sources are depleted, there are not sufficient funds to pay the fixed prizes awarded, then all fixed prizes shall become pari-mutuel prizes, and the amount remaining in the Fixed Prize Pool shall be divided among the winning plays in proportion to their respective prize percentages.

(7) The Fixed Prize Pool shall consist of 50 percent (50%) of the prize pool for the drawing plus any fixed prize money carried forward from the previous draws. The Fixed Prize Pool will be allocated to a number of subcategory fixed $1 million, $100,000, $10000, and $500 prizes, defined by the following formula:
(a) Seventy-five percent (75%) of the Fixed Prize pool, rounded down to the nearest million dollar denomination, shall be allocated to the maximum number of million dollar prize units;
(b) Seventy-five percent (75%) of the remaining Fixed Prize pool, rounded down to the nearest hundred thousand dollar denomination, shall be allocated to the maximum number of hundred thousand dollar prize units;
(c) Seventy-five percent (75%) of the remaining Fixed Prize pool, rounded down to the nearest ten thousand dollar denomination, shall be allocated to the maximum number of ten thousand dollar prize units;
(d) One hundred percent (100%) of the remaining Fixed Prize pool, rounded down to the nearest five hundred dollar denomination, shall he allocated to the maximum number of five hundred dollar prize units;
(e) One hundred percent (100%) of the remaining Fixed Prize pool shall be placed in trust in one or more prize reserve accounts for QP lottery ticket prizes, until the prize reserve accounts reach the amounts designated by the Lottery. Once the prize reserve accounts exceed the designated amounts, the excess shall become part of the subsequent Fixed Prize pool.

(8) The allocation of the Fixed Prize pool may be modified by the Lottery from time to time to include a number of subcategories, including Ten Million Dollar prize units ($10,000,000), Five Million Dollar prize units ($5,000,000), Two Million Dollar prize units ($2,000,000), One Million Dollar prize units ($1,000,000), Five Hundred Thousand Dollar prize units ($500,000), Two Hundred Fifty Thousand Dollar prize units ($250,000), One Hundred Thousand Dollar prize units ($100,000). Fifty Thousand Dollar prize units ($50,000), Twenty Five Thousand Dollar prize units ($25,000), Ten Thousand Dollar prize units ($10,000), Five Thousand Dollar prize units ($5,000), One Thousand Dollar prize units ($1,000), Five Hundred Dollar prize units ($500), Two Hundred Fifty Dollar prize units ($250), One Hundred Dollar prize units ($100), and QP lottery ticket prize units.

(9) Modification of the Fixed Prize pool allocation shall only occur when the Lottery has determined in writing prior to the drawing that circumstances warrant the modification of such allocation amounts to positively impact sales. No more than 75% of the Fixed Prize pool may be allocated to any one subcategory in a given drawing. Under no circumstances can a fixed prize allocation in any drawing be modified after being published by the Lottery. Nothing in this rule shall be construed to prohibit a guaranteed Fixed Prize.

(10) If a Fixed Prize winner in a drawing did not purchase the Lightning Strikes Twice™ add-on game at the time the base game play was purchased, the winner will receive a free QP lottery ticket in lieu of the associated Fixed Prize. The Fixed Prize amount allocated to that winning Raffle Ticket will not he awarded and shall be carried over and added to the Fixed Prize pool of the subsequent Lightning Strikes Twice™ drawing.

(11) Except for the Grand Prize payout, as provided in these rules, all other prizes awarded shall be paid as fixed lump sum prizes.

VII. Probability of Winning

(1) The following table sets forth the overall probability of winning a Lightning Strikes Twice™ Grand Prize, based on the overall odds of matching at least 3 official winning numbers in a base jackpot game and an estimated number of Lightning Strikes Twice™ players in a given raffle period. The odds of winning a raffle prize are determined by the number of raffle tickets issued and number of prizes offered in a given drawing.

(2) Matching at least 3 official winning numbers in a Jackpot Game:

| Base Jackpot Game | Overall Odds |
|---|---|
| Lotto ™ | 1:67.36 |

(3) Winning the Lightning Strikes Twice™ grand prize in a weekly raffle period: 1:330,000 (estimated)

VIII. Lightning Strikes Twice™ Estimated Prizes

(1) For each drawing the Lottery will announce the estimated amount of the Lightning Strikes Twice™ Grand Prize (estimated annuity value) that can be won by a single player, based upon the estimated cash value of the Grand Prize Pool determined by projected and historical sales figures, current interest rates, and funds from rollovers, if any. In the event the cash available in the Grand Prize pool is insufficient to yield the announced estimated Grand Prize value over the annuitized payment period, the Lottery may add prize money from prize reserve accounts or from prize money rendered unclaimable by State Statutes, to the Grand Prize pool to render it sufficient to yield the announced estimated Grand Prize. Use of prize reserve accounts or unclaimable prize money to increase the Grand Prize pool for the Lightning Strikes Twice™ add-on game shall only occur when the Lottery has determined in writing prior to the drawing that circumstances warrant the use of such funds to positively impact sales. Nothing in this rule shall be construed to prohibit a guaranteed Grand Prize.

(2) For each drawing the Lottery will announce the estimated amount of various Fixed Prizes that can be won by a single player, based upon the estimated cash value of the Fixed Prize Pool determined by projected and historical sales figures, current interest rates, and funds from rollovers, if any. In the event, the cash available in the Fixed Prize Pool is insufficient to yield the announced estimated Fixed Prize values in single payments, the Lottery may add prize money from prize reserve accounts or from prize money rendered unclaimable by State Statutes or by Lightning Strikes Twice™ game rules, to the Fixed Prize Pool to render it sufficient to yield the announced estimated Fixed Prizes. Use of prize reserve accounts or unclaimable prize money to increase the Fixed Prize pool for the Lightning Strikes Twice™ add-on game shall only occur when the Lottery has determined in writing prior to the drawing that circumstances warrant the use of such funds to positively impact sales. Nothing in this rule shall be construed to prohibit a guaranteed Fixed Prize.

IX. Grand Prize Payment Options

(1) Grand prizes shall be paid not later than . . . days after validation of the prize, with either an annuity or single lump sum payment. If the payment election is not made by the player within . . . days after validation, then the prize shall be paid as an annuity prize. The election to take the single lump sum payment may be made at the time of validation of the prize claim or within . . . days thereafter. An election made after validation is final and cannot be revoked, withdrawn or otherwise changed. Winner(s) who elect a lump sum payment shall be paid in a single lump sum payment. The annuitized option prize shall be determined by multiplying the Grand Prize pool by the Lightning Strikes Twice™ annuity factor. (Application of the Lightning Strikes Twice™ annuity factor generally is anticipated to result in the Grand Prize winner who elects a single lump sum payment receiving an amount that roughly approximates one-half of the advertised jackpot amount. The actual single lump sum payment amount will vary as a function of the Lightning Strikes Twice™ annuity factor determined as described in subsection (4) of this rule.) The Lightning Strikes Twice™ annuity factor is determined by the best total securities price obtained through a competitive bid of qualified, pre-approved brokers made after it is determined that the prize is to be paid as an annuity prize or after the expiration of . . . days after the winner becomes entitled to the prize. The Lottery shall not be responsible or liable for changes in the advertised or estimated annuity prize amount and the actual amount purchased after the prize payment method is actually known to the Lottery. In certain instances announced by the Lottery, the Grand Prize shall be a guaranteed amount and shall be determined pursuant to subsection (4) of this rule. If the cash held to fund an annuity is less than $250,000, the Lottery, in its sole discretion, may elect to pay the winners the amount held in the Grand Prize pool. All annuitized prizes shall be paid annually in thirty equal payments with the initial payment being made directly with available funds, to be followed by twenty-nine payments funded by the annuity. Annual payments after the initial payment shall be made by the lottery on the anniversary date of the first payment or if such date fails on a non-business day, then the first business day following the anniversary date of the Lightning Strikes Twice™ drawing.

(2) Annuitized payments of the Grand Prize may be rounded to facilitate the purchase of an appropriate funding mechanism. Breakage on an annuitized Grand Prize win shall be added to the first payment to the winner or winners.

(3) If the Grand Prize is not won in a drawing, the prize money allocated for the Grand Prize shall roll over and be added to the Grand Prize pool for the following drawing. If any Fixed Prizes are not won in a drawing, the prize money allocated for the Fixed Prizes shall roll over and be added to the Fixed Prize pool for the following drawing.

(4) If the Grand Prize winner during a single drawing has elected the annuitized option prize, then the best bid submitted by the Lottery's pre-approved qualified brokers shall determine the cash pool needed to fund the guaranteed annuitized Grand Prize. If the winner of the Grand Prize during a single drawing has not elected the annuitized option prize, then the amount of the cash in the Grand Prize pool shall be an amount equal to the guaranteed annuitized amount divided by the average annuity factor of the most recent three best quotes provided by the Lottery's pre-approved qualified brokers submitting quotes In no case shall quotes be used which are more than two weeks old, and if less than three quotes are submitted, then the Lottery shall use the average of all quotes submitted. Changes in the allocation of prize money shall be designed to retain approximately the same prize allocation percentages, over a year's time, set out in these rules.

(5) The holder of a winning ticket may win only one prize per ticket in connection with the winning raffle numbers drawn, and shall be entitled only to the prize won by those numbers in the highest matching prize category.

(6) Any interest or earnings accrued on a Lightning Strikes Twice™ Grand prize or Fixed Prize prior to the prize payment, under either the Cash Option or the Annual Payment option, shall accrue to the State and not to the winner.

The best mode for carrying out the operational method for express distribution of game plays as taught in one embodiment of the present invention would be for the lottery authority to strategically create as many “impulse opportunities” for players as possible. A primary focus of the lottery authority for maximum sustained growth is four-fold: (1) Begin building a player database where an electronic communication relationship can be nurtured. (2) Invest in the technology to allow players direct access through their own electronic devices and begin to minimize or phase out retailers as the primary interface between the lottery authority and players as the direct relationship with players strengthens. (3) Maintain a strong promotional campaign encouraging players to register & purchase through “express” terminal interfaces, which offers superior benefits, such as associating purchased game plays to players, eliminating the physical ticket requirement; electronic receipts and electronic communication of the game play outcome, and/or automatic transfer of winnings to a players account, whereby the lottery authority receives a nominal fee.

The following US applications/patents are incorporated by reference herein in their entireties: Ser. Nos. 13/475,943; 12/671,513; PCT/US08/70392; Ser. Nos. 13/372,623; 11/906,597; and 11/882,147.

What is claimed is:

1. A method, comprising:
offering an add-on raffle game play to players who are playing a lottery;
generating a lottery ticket with a set of player indicia and an indication if the add-on raffle game play was purchased;
determining that game play outcome qualifies the lottery ticket for a raffle ticket;
wherein the add-on raffle game play provides that a first prize is awarded if the raffle ticket wins a raffle and the add-on raffle game play was purchased with the lottery ticket, and
a second prize is awarded if the raffle ticket wins the raffle and the add-on raffle game play was not purchased with the lottery ticket.
